(19) United States
(12) Patent Application Publication
(10) Pub. No.: US 2012/0225283 A1
(43) Pub. Date: Sep. 6, 2012

(54) OPTICAL FILM HAVING ANTISTATIC LAYER, AND ANTIREFLECTION FILM, POLARIZING PLATE AND IMAGE DISPLAY DEVICE USING THE SAME

(75) Inventors: Makoto UCHIMURA, Kanagawa (JP); Masato NAKAO, Kanagawa (JP)

(73) Assignee: FUJIFILM CORPORATION, Tokyo (JP)

(21) Appl. No.: 13/409,873

(22) Filed: Mar. 1, 2012

(30) Foreign Application Priority Data
Mar. 1, 2011 (JP) 2011-044548

(51) Int. Cl. B32B 5/16; B32B 27/00; G02B 1/04

(52) U.S. Cl. 428/323; 252/500; 428/500

(57) ABSTRACT

There is provided an optical film comprising a transparent support having thereon at least one layer of an antistatic layer formed of a composition containing at least the following (A) to (D): (A) an electrically conductive polymer, (B) a polyfunctional monomer having two or more polymerizable group, (C) a non-aromatic alcohol compound having four or more hydroxyl groups, and (D) a photopolymerization initiator.

### CROSS-REFERENCE TO RELATED APPLICATIONS

This application claims priority from Japanese Patent Application No. 2011-44548, filed Mar. 1, 2011, the contents of all of which are hereby incorporated by reference in their entirety.

### BACKGROUND OF THE INVENTION

1. Field of the Invention

The present invention relates to an optical film having an antistatic layer, an antireflection film and a polarizing plate each using the optical film, and an image display device using the optical film or polarizing plate for an outermost surface of a display.

2. Description of the Related Art

In the fields of optics, precision machines, building materials, household electrical appliances, etc., it is considered to be useful to stick a film having antistatic performances for the purpose of preventing dust attachment, electrical circuit fault, etc. from occurring. Above all, in the field of household electrical appliances, from the viewpoints of dustproof properties and countermeasure against faults at the time of panel processing, antistatic properties are required for protective films to be applied to image display devices such as a cathode ray tube (CRT), a plasma display panel (PDP), an electroluminescence display (ELD), and a liquid display device (LCD).

For the purpose of imparting antistatic properties to an optical film, there is known a method of using an electrically conductive polymer. In particular, π-conjugated electrically conductive polymers such as polythiophene and polyaniline are useful as an antistatic material because they do not have humidity dependence. But, the electrically conductive polymer alone does not have sufficient film strength, so that it was problematical as a surface film. As to this problem, there are disclosed coating films composed of an electrically conductive polymer and a curable binder (see, for example, JP-A-2004-91618, JP-A-2006-176681). However, such coating films involved such a problem that they are poor in durability such as light resistance, heat resistance, and resistance to humidity and heat, especially light resistance, and their electrical conductivity is largely deteriorated upon irradiation with light.

On the other hand, for the purpose of enhancing the electrical conductivity or durability, it is proposed to allow a “compound having two or more hydroxyl groups” to contain as an electrical conductivity enhancing agent in an electrically conductive polymer (see JP-A-2008-75001). However, JP-A-2008-75001 describes that when such an electrical conductivity enhancing agent and a curable binder are used in combination, an effect for enhancing the electrical conductivity or durability is compensated.

Also, for the purpose of enhancing the electrical conductivity or durability, it is proposed to use a mixture of a “hydroxyl group-containing aromatic compound having two or more hydroxyl groups bound to an aromatic ring” with an electrically conductive polymer (see, for example, JP-A-2006-265297).

### SUMMARY OF THE INVENTION

However, the present inventors have found that in a coating film composed of an electrically conductive polymer and a curable binder, in order to maintain the light resistance, if the content of the electrically conductive polymer is increased, there are involved problems such as a lowering of hardness of the coating film and a lowering of transmittance to be caused due to coloration, so that improvements are needed.

Also, the present inventors have found that at the time of using a binder capable of being cured by radical polymerization and an additive described in JP-A-2006-265297 in combination, there may be the case where the additive works as a radical trap, the polymerization is inhibited, and curing of the coating film does not proceed, so that film-forming properties are not revealed, or the film strength as a surface film is not sufficient.

In view of the foregoing problems of the related art, an object of the invention is to provide an optical film equipped with an antistatic layer, which is strong in film strength and excellent in all of electrical conductivity, durability such as light resistance, and transparency, and an antireflection film, a polarizing plate, and an image display device, each using the same.

In order to solve the foregoing problems, the present inventors made extensive and intensive investigations. As a result, it has been found that by allowing a composition containing an electrically conductive polymer and a curable binder to further contain a non-aromatic alcohol compound having four or more hydroxyl groups, in view of the fact that the foregoing non-aromatic alcohol compound has low radical trapping ability, high film strength and electrical conductivity can be achieved without hindering polymerization of the foregoing binder, leading to accomplishment of the invention.

[1] An optical film comprising a transparent support having thereon at least one layer of an antistatic layer formed of a composition containing at least the following (A) to (D):

(A) an electrically conductive polymer,

(B) a polyfunctional monomer having two or more polymerizable group,

(C) a non-aromatic alcohol compound having four or more hydroxyl groups, and

(D) a photopolymerization initiator.

[2] The optical film according to [1] above, wherein the non-aromatic alcohol compound (C) is an aliphatic hydrocarbon compound having a main chain structure with a carbon number of 4 or more.
[3] The optical film according to [1] or [2] above, wherein the non-aromatic alcohol compound (C) has from four to six hydroxyl groups.
[4] The optical film according to any one of [1] to [3] above, wherein the main chain structure of the non-aromatic alcohol compound (C) is linear.
[5] The optical film according to any one of [1] to [4] above, wherein the hydroxyl group equivalent (molecular weight/number of hydroxyl groups) of the non-aromatic alcohol compound (C) is 40 or less.
[6] The optical film according to any one of [1] to [5] above, wherein the molecular weight of the polyfunctional monomer (B) is 400 or less.
[7] The optical film according to any one of [1] to [6] above, wherein a common logarithmic value (log SR) of a surface resistivity SR (Ω/sq) of the optical film is in the range of from 6 to 12.
[8] The optical film according to any one of [1] to [7] above, wherein the electrically conductive polymer (A) contains at least any one of polythiophene, polyaniline, polypyrrole, and derivatives thereof.
[9] The optical film according to any one of [1] to [8] above, wherein the electrically conductive polymer (A) contains at least any one of polythiophene and derivatives thereof.
[10] The optical film according to any one of [1] to [9] above, wherein the electrically conductive polymer (A) contains poly(3,4-ethylenedioxy)thiophene.
[11] The optical film according to any one of [1] to [10] above, further comprising polystyrenesulfonic acid as a dopant of the electrically conductive polymer (A).
[12] The optical film according to any one of [1] to [11] above, wherein the composition further contains (E) a fluorine based or silicone based surfactant.
[13] The optical film according to any one of [1] to [12] above, wherein the antistatic layer contains a translucent particle having an average particle diameter of from 0.5 to 20
[14] An antireflection film comprising the antistatic layer of the optical film according to any one of [1] to [13] above having thereon a low refractive index layer directly or via other layer.
[15] A polarizing plate utilizing, as a protective film for polarizing plate, the optical film according to any one of [1] to [13] above or the antireflection film according to [14] above.
[16] An image display device comprising the optical film according to any one of [1] to [13] above, the antireflection film according to [14] above, or the polarizing plate according to [15] above on an outermost surface of a display.

According to the invention, an optical film equipped with an antistatic layer, which is strong in film strength and excellent in all of electrical conductivity, durability such as light resistance, and transparency, and an antireflection film, a polarizing plate, and an image display device, each using the same.

### DETAILED DESCRIPTION OF THE INVENTION

The invention is hereunder described in detail.

The optical film of the invention has at least one layer of an antistatic layer formed of a composition containing at least the following (A) to (D). It is preferable that the optical film of the invention is formed by coating a coating composition containing the following (A) to (D) components on a transparent support and curing:

(A) an electrically conductive polymer,

(B) a polyfunctional monomer having two or more polymerizable group,

(C) a non-aromatic alcohol compound having four or more hydroxyl groups, and

(D) a photopolymerization initiator.

The respective components which are contained in the composition for forming an antistatic layer in the invention are hereunder described.

### [(A) Electrically Conductive Polymer]

Any materials such as polymer compounds which are used as an electrically conductive polymer in the present business field can be used as the electrically conductive polymer in the invention.

The electrically conductive polymer is preferably a non-conjugated polymer or a conjugated polymer in which an aromatic carbon ring or an aromatic hetero ring is connected with a single bond or a divalent or polyvalent connecting group. Examples of the aromatic carbon ring in the non-conjugated polymer or conjugated polymer include a benzene ring, and furthermore, the aromatic carbon ring may form a condensed ring. Examples of the aromatic hetero ring in the non-conjugated polymer or conjugated polymer include a pyridine ring, a pyrazine ring, a pyrimidine ring, a pyridazine ring, a triazine ring, an oxazole ring, a thiazole ring, an imidazole ring, an oxadiazole ring, a thiadiazole ring, a triazole ring, a tetrazole ring, a furan ring, a thiophene ring, a pyrrole ring, an indole ring, a carbazole ring, a benzoimidazole ring, and an imidazopyridine ring, and furthermore, the aromatic hetero ring may form a condensed ring or may have a substituent.

Also, examples of the divalent or polyvalent connecting group in the non-conjugated polymer or conjugated polymer include connecting groups formed by a carbon atom, a silicon atom, a nitrogen atom, a boron atom, an oxygen atom, a sulfur atom, a metal, a metal ion, or the like. Of these, groups formed by a carbon atom, a nitrogen atom, a silicon atom, a boron atom, an oxygen atom, a sulfur atom, or a combination thereof are preferable. Examples of the group formed by a combination include a substituted or unsubstituted methylene group, a substituted or unsubstituted carbonyl group, a substituted or unsubstituted imino group, a substituted or unsubstituted sulfonyl group, a substituted or unsubstituted sulfinyl group, a substituted or unsubstituted ester group, a substituted or unsubstituted amide group, and a substituted or unsubstituted silyl group.

Specific examples of the electrically conductive polymer include substituted or unsubstituted electrically conductive polyaniline, polyparaphenylene, polyparaphenylene vinylene, polythiophene, polyfuran, polypyrrole, polyselenophene, polyisothianaphthene, polyphenylene sulfide, polyacetylene, polypyridyl vinylene, polyazine, and derivatives thereof. One of these polymers may be used alone, or two or more kinds thereof may be used in combination according to the purpose.

Also, so far as the desired electrical conductivity can be obtained, the polymer can be used as a mixture with other polymer having no electrical conductivity, or a copolymer of a monomer capable of constituting an electrically conductive polymer and other monomer having no electrical conductivity can be used.

The electrically conductive polymer is more preferably a conjugated polymer. Examples of the conjugated polymer include polyacetylene, polydiacetylene, poly(paraphenylene), polyfluorene, polyazulene, poly(paraphenylene sulfide), polypyrrole, polythiophene, polyisothianaphthene, polyaniline, poly(paraphenylene vinylene), poly(2,5-thienylene vinylene), a double chain-type conjugated polymer (for example, polyperinaphthalene, etc.), a metallophthalocyanine based polymer, other conjugated polymers (for example, poly(paraxylylene), poly[α-(5,5′-bithiophenediyl)benzylidene], etc.), and derivatives thereof.

Of these, poly(paraphenylene), polypyrrole, polythiophene, polyaniline, poly(paraphenylene vinylene), and poly(2,5-thienylene vinylene) are preferable; polythiophene, polyaniline, polypyrrole, and derivatives thereof are more preferable; and at least any one of polythiophene and derivatives thereof is still more preferable.

Such a conjugated polymer may have a substituent, and examples of the substituent which such a conjugated polymer may have include substituents described as R¹¹ in the general formula (I) as described later.

In particular, from the standpoint of obtaining an optical film satisfying both high transparency and high antistatic properties, it is preferable that the electrically conductive polymer has a partial structure represented by the following general formula (I) (that is, the polymer is polythiophene or a derivative thereof).

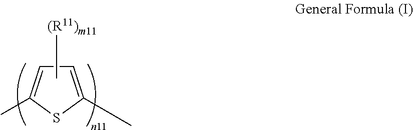

In the general formula (I), R¹¹ represents a substituent; and m11 represents an integer of from 0 to 2. When m11 represents 2, then each R¹¹ may be the same as or different from every other R¹¹, and R¹¹s may be connected to each other to form a ring. n11 represents an integer of 1 or more.

Examples of the substituent represented by R¹¹ include an alkyl group (preferably having a carbon number of from 1 to 20, more preferably a carbon number of from 1 to 12, and still more preferably a carbon number of from 1 to 8; for example, methyl, ethyl, isopropyl, tert-butyl, n-octyl, n-decyl, n-hexadecyl, cyclopropyl, cyclopentyl, cyclohexyl, etc.), an alkenyl group (preferably having a carbon number of from 2 to 20, more preferably a carbon number of from 2 to 12, and especially preferably a carbon number of from 2 to 8; for example, vinyl, allyl, 2-butenyl, 3-pentenyl, 2-hexenyl, 3-hexenyl, 4-hexenyl, 2-octenyl, etc.), an alkynyl group (preferably having a carbon number of from 2 to 20, more preferably a carbon number of from 2 to 12, and especially preferably a carbon number of from 2 to 8; for example, propargyl, 3-pentynyl, etc.), an aryl group (preferably having a carbon number of from 6 to 30, more preferably a carbon number of from 6 to 20, and especially preferably a carbon number of from 6 to 12; for example, phenyl, p-methylphenyl, naphthyl, etc.), an amino group (preferably having a carbon number of from 0 to 20, more preferably a carbon number of from 0 to 10, and especially preferably a carbon number of from 0 to 6; for example, amino, methylamino, dimethylamino, diethylamino, dibenzylamino, diphenylamino, etc.),

an alkoxy group (preferably having a carbon number of from 1 to 20, more preferably a carbon number of from 1 to 12, and especially preferably a carbon number of from 1 to 8; for example, methoxy, ethoxy, butoxy, hexyloxy, octyloxy, etc.), an aryloxy group (preferably having a carbon number of from 6 to 20, more preferably a carbon number of from 6 to 16, and especially preferably a carbon number of from 6 to 12; for example, phenyloxy, 2-naphthyloxy, etc.), an acyl group (preferably having a carbon number of from 1 to 20, more preferably a carbon number of from 1 to 16, and especially preferably a carbon number of from 1 to 12; for example, acetyl, benzoyl, formyl, pivaloyl, etc.), an alkoxycarbonyl group (preferably having a carbon number of from 2 to 20, more preferably a carbon number of from 2 to 16, and especially preferably a carbon number of from 2 to 12; for example, methoxycarbonyl, ethoxycarbonyl, etc.), an aryloxycarbonyl group (preferably having a carbon number of from 7 to 20, more preferably a carbon number of from 7 to 16, and especially preferably a carbon number of from 7 to 10; for example, phenyloxycarbonyl, etc.),
an acyloxy group (preferably having a carbon number of from 2 to 20, more preferably a carbon number of from 2 to 16, and especially preferably a carbon number of from 2 to 10; for example, acetoxy, benzoyloxy, etc.), an acylamino group (preferably having a carbon number of from 2 to 20, more preferably a carbon number of from 2 to 16, and especially preferably a carbon number of from 2 to 10; for example, acetylamino, benzoylamino, etc.), an alkoxycarbonylamino group (preferably having a carbon number of from 2 to 20, more preferably a carbon number of from 2 to 16, and especially preferably a carbon number of from 2 to 12; for example, methoxycarbonylamino, etc.), an aryloxycarbonylamino group (preferably having a carbon number of from 7 to 20, more preferably a carbon number of from 7 to 16, and especially preferably a carbon number of from 7 to 12; for example, phenyloxycarbonylamino, etc.), a sulfonylamino group (preferably having a carbon number of from 1 to 20, more preferably a carbon number of from 1 to 16, and especially preferably a carbon number of from 1 to 12; for example, methanesulfonylamino, benzenesulfonylamino, etc.), a sulfamoyl group (preferably having a carbon number of from 0 to 20, more preferably a carbon number of from 0 to 16, and especially preferably a carbon number of from 0 to 12; for example, sulfamoyl, methylsulfamoyl, dimethylsulfamoyl, phenylsulfamoyl, etc.),
a carbamoyl group (preferably having a carbon number of from 1 to 20, more preferably a carbon number of from 1 to 16, and especially preferably a carbon number of from 1 to 12; for example, carbamoyl, methylcarbamoyl, diethylcarbamoyl, phenylcarbamoyl, etc.), an alkylthio group (preferably having a carbon number of from 1 to 20, more preferably a carbon number of from 1 to 16, and especially preferably a carbon number of from 1 to 12; for example, methylthio, ethylthio, etc.), an arylthio group (preferably having a carbon number of from 6 to 20, more preferably a carbon number of from 6 to 16, and especially preferably a carbon number of from 6 to 12; for example, phenylthio, etc.), a sulfonyl group (preferably having a carbon number of from 1 to 20, more preferably a carbon number of from 1 to 16, and especially preferably a carbon number of from 1 to 12; for example, mesyl, tosyl, etc.), a sulfinyl group (preferably having a carbon number of from 1 to 20, more preferably a carbon number of from 1 to 16, and especially preferably a carbon number of from 1 to 12; for example, methanesulfinyl, benzenesulfinyl, etc.), a ureido group (preferably having a carbon number of from 1 to 20, more preferably a carbon number of from 1 to 16, and especially preferably a carbon number of from 1 to 12; for example, ureido, methylureido, phenylureido, etc.), a phosphoric acid amide group (preferably having a carbon number of from 1 to 20, more preferably a carbon number of from 1 to 16, and especially preferably a carbon number of from 1 to 12; for example, diethylphosphoric acid amide, phenylphosphoric acid amide, etc.),
a hydroxyl group, a mercapto group, a halogen atom (for example, a fluorine atom, a chlorine atom, a bromine atom, and an iodine atom), a cyano group, a sulfo group, a carboxyl group, a nitro group, a hydroxamic acid group, a sulfino group, a hydrazino group, an imino group, a heterocyclic group (preferably having a carbon number of from 1 to 20, and more preferably a carbon number of from 1 to 12; examples of the heteroatom include a nitrogen atom, an oxygen atom, and a sulfur atom; specifically, for example, pyrrolidine, piperidine, piperazine, morpholine, thiophene, furan, pyrrole, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phthalazine, naphthylidine, quinoxaline, quinazoline, cinnoline, pteridine, acridine, phenanthroline, phenazine, tetrazole, benzimidazole, benzoxazole, benzothiazole, benzotriazole, and tetrazaindene), and a silyl group (preferably having a carbon number of from 3 to 40, more preferably a carbon number of from 3 to 30, and especially preferably a carbon number of from 3 to 24; for example, trimethylsilyl, triphenylsilyl, etc.).

The substituent represented by R¹¹ may be further substituted. Also, in the case where the substituent has a plurality of substituents, these substituents may be the same or different, and if possible, they may be connected to each other to form a ring. Examples of the ring which is formed include a cycloalkyl ring, a benzene ring, a thiophene ring, a dioxane ring, and a dithiane ring.

The substituent represented by R¹¹ is preferably an alkyl group, an alkenyl group, an alkynyl group, an alkoxy group, or an alkylthio group, and more preferably an alkyl group, an alkoxy group, or an alkylthio group. Especially preferably, it is suitable that when m11 is 2, two R¹¹s are an alkoxy group or an alkylthio group and form a ring, and more preferably a dioxane ring or a dithiane ring.

In the general formula (I), when m11 is 1, R¹¹ is preferably an alkyl group, and more preferably an alkyl group having a carbon number of from 2 to 8.

So far as n11 is an integer of 1 or more, though n11 is not particularly limited, n11 is preferably an integer of from 1 to 1,000.

Also, when R¹¹ is a poly(3-alkylthiophene) that is an alkyl group, a linkage mode between the adjacent thiophene rings includes a stereoregular mode in which all rings are linked by a 2-5′ linkage; and a stereoirregular mode containing a 2-2′ linkage and a 5-5′ linkage, with a stereoirregular mode being preferable.

In the invention, from the standpoint of satisfying both high transparency and high electrical conductivity, the electrically conductive polymer is especially preferably poly(3,4-ethylenedioxy)thiophene (PEDOT, Compound (6) in specific examples shown below).

The polythiophene represented by the general formula (I) and derivatives thereof can be fabricated by a known method described in, for example, J. Mater. Chem., 15, 2077 to 2088 (2005) and Advanced Materials, 12(7), page 481 (2000). Also, these are available as a commercial product such as Denatron P502 (manufactured by Nagase ChemteX Corporation); and 3,4-ethylenedioxythiophene (BAYTRON (a registered trademark) M V2), 3,4-polyethylenedioxythiopene/polystyrene sulfonate (BAYTRON (a registered trademark) P), BAYTRON (a registered trademark) C, BAYTRON (a registered trademark) F E, BAYTRON (registered trademark) M V2, BAYTRON (a registered trademark) P, BAYTRON (a registered trademark) P AG, BAYTRON (a registered trademark) P HC V4, BAYTRON (a registered trademark) P HS, BAYTRON (a registered trademark) PH, BAYTRON (a registered trademark) PH 500, and BAYTRON (a registered trademark) PH 510 (all of which are manufactured by H.C. Starck GmbH).

As to the polyaniline and derivatives thereof, for example, Polyaniline (manufactured by Aldrich Chemical Company, Inc.) and Polyaniline (emeraldine salt) (manufactured by Aldrich Chemical Company, Inc.) are available.

As to the polypyrrole and derivatives thereof, for example, Polypyrrole (manufactured by Aldrich Chemical Company, Inc.) is available.

Specific examples of the electrically conductive polymer are illustrated below, but it should not be construed that the invention is limited thereto. Other examples include compounds described in International Publication No. WO 98/01909.

In the following formulae, each of x and y independently represents an integer of 1 or more.

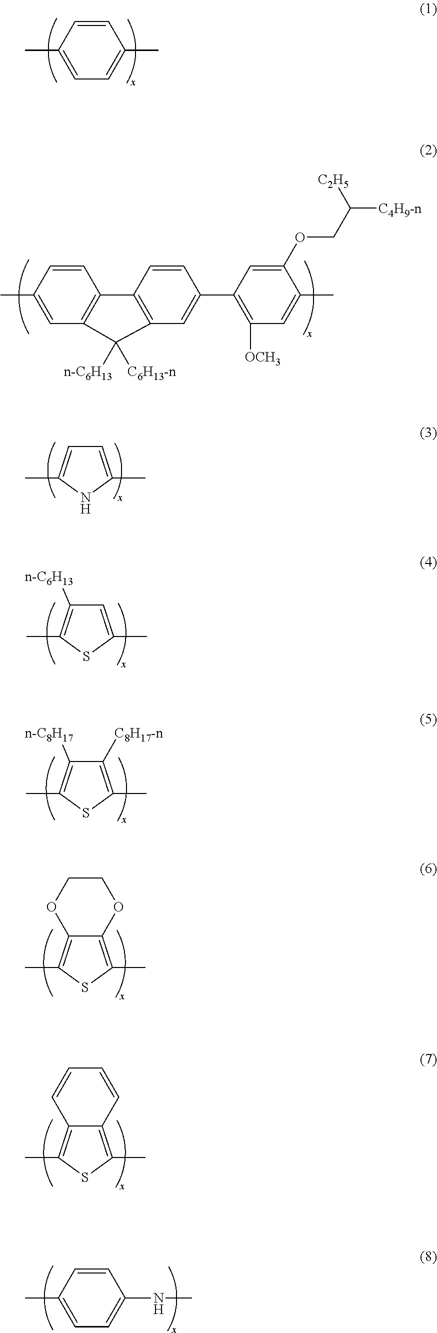

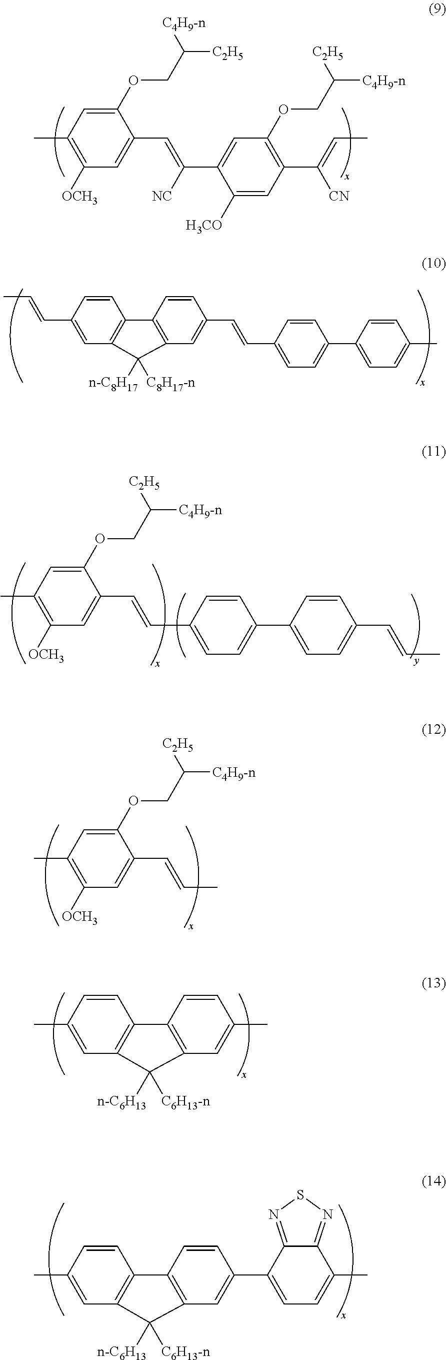

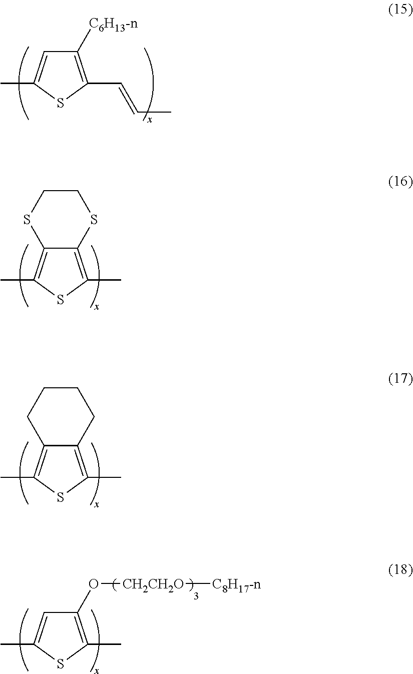

A weight average molecular weight of the electrically conductive polymer which is used in the invention is preferably from 1,000 to 1,000,000, more preferably from 10,000 to 500,000, and still more preferably from 10,000 to 100,000. The weight average molecular weight as referred to herein is a weight average molecular weight as reduced into polystyrene as measured by gel permeation chromatography.

### (Solubility in Organic Solvent)

From the viewpoints of coatability and impartation of affinity with the component (B), it is preferable that the electrically conductive polymer is soluble in an organic solvent.

More specifically, the electrically conductive polymer in the invention is preferably soluble in an amount of at least 1.0% by mass in an organic solvent having a water content of not more than 5% by mass and a dielectric constant of from 2 to 30.

The term “soluble” as referred to herein indicates that the polymer is dissolved in a single molecular state or in an associated state of a plurality of single molecules, or is dispersed in a particulate state with a particle diameter of not more than 300 nm.

In general, the electrically conductive polymer has high hydrophilicity and is conventionally dissolved in a solvent composed mainly of water. However, in order to solubilize such an electrically conductive polymer in an organic solvent, there are exemplified a method of adding a compound capable of increasing the affinity with an organic solvent (for example, a solubilization aid as described later, etc.) to a composition containing the electrically conductive polymer; and a method of adding a dispersant or the like to an organic solvent. Also, in the case of using an electrically conductive polymer and a polyanion dopant, it is preferable to perform a hydrophobilization treatment of the polyanion dopant as described later.

Furthermore, there can be adopted a method in which an electrically conductive polymer in a dedoped state (in a state of not using a dopant) is enhanced in its solubility in an organic solvent, and a dopant is added after the formation of a coated film to develop the electrical conductivity.

In addition to the above, methods described in the following documents are also preferably adopted as the method for enhancing the solubility in an organic solvent.

For example, JP-A-2002-179911 describes a method in which a polyaniline composition in a dedoped state is dissolved in an organic solvent, the resulting material is coated on a base material and dried, and the coating is subjected to an oxidation and doping treatment with a solution having a protonic acid and an oxidizing agent dissolved or dispersed therein, thereby developing the electrical conductivity.

Also, International Publication No. WO 05/035626 describes a method for manufacturing an electrically conductive polyaniline, in which at the time of oxidatively polymerizing aniline or a derivative thereof in a mixed layer composed of an aqueous layer and an organic layer in the presence of at least one of a sulfonic acid and a water-insoluble organic polymer compound having a protonic acid group, the polymer is stably dispersed in an organic solvent by allowing a molecular weight modifier and optionally, a phase transfer catalyst to coexist.

For example, alcohols, aromatic hydrocarbons, ethers, ketones, esters, and so on are suitable as the organic solvent. Specific examples of these compounds are described below (a dielectric constant is shown in each of the following parentheses).

The alcohols include, for example, a monohydric alcohol and a dihydric alcohol. Of these, the monohydric alcohol is preferably a saturated aliphatic alcohol having a carbon number of from 2 to 8. Specific examples of the alcohols include ethyl alcohol (25.7), n-propyl alcohol (21.8), isopropyl alcohol (18.6), n-butyl alcohol (17.1), sec-butyl alcohol (15.5), and tert-butyl alcohol (11.4).

Also, specific examples of the aromatic hydrocarbons include benzene (2.3), toluene (2.2), and xylene (2.2); specific examples of the ethers include tetrahydrofuran (7.5), ethylene glycol monomethyl ether (16), ethylene glycol monomethyl ether acetate (8), ethylene glycol monoethyl ether (14), ethylene glycol monoethyl ether acetate (8), and ethylene glycol monobutyl ether (9); specific examples of the ketones include acetone (21.5), diethyl ketone (17.0), methyl ethyl ketone (15.5), diacetone alcohol (18.2), methyl isobutyl ketone (13.1), and cyclohexanone (18.3); and specific examples of the esters include methyl acetate (7.0), ethyl acetate (6.0), propyl acetate (5.7), and butyl acetate (5.0).

From the viewpoint that both the electrically conductive polymer and the polyfunctional monomer (B) having two or more polymerizable groups can be dissolved and dispersed, the dielectric constant of the organic solvent is more preferably from 2.3 to 24, still more preferably from 4.0 to 21, and most preferably from 5.0 to 21. For example, isopropyl alcohol, acetone, propylene glycol monoethyl ether, cyclohexanone, and methyl acetate are preferable, with isopropyl alcohol, acetone, and propylene glycol monoethyl ether being especially preferable.

In the invention, the dielectric constant indicates a value measured at 20° C.

A mixture of two or more kinds of organic solvents having a dielectric constant of from 2 to 30 can also be used. An organic solvent having a dielectric constant exceeding 30, or water in an amount of not more than 5% by mass can be used in combination, but it is preferable that in the above-described mixed organic solvent system containing the organic solvent, the mass average dielectric constant of a plurality of organic solvents or water does not exceed 30. By allowing the dielectric constant of the organic solvent to fall within the foregoing range, a coating composition in which both the electrically conductive polymer and the polyfunctional monomer (B) having two or more polymerizable groups are dissolved or dispersed can be formed, and a laminate having a favorable surface profile of the coating film can be obtained.

A water content of the organic solvent is preferably from 0 to 5% by mass, and more preferably from 0 to 1% by mass.

The electrically conductive polymer is preferably soluble in an organic solvent at a concentration of at least 1.0% by mass, more preferably at a concentration of at least from 1.0 to 10.0% by mass, and still more preferably at a concentration of at least from 3.0 to 30.0% by mass.

In the organic solvent, the electrically conductive polymer may exist in a particulate state. In that case, an average particle size thereof is preferably not more than 300 nm, more preferably from 200 nm, and still more preferably not more than 100 nm. By allowing the particle size to fall within the foregoing range, precipitation of particles in the organic solvent can be suppressed. A lower limit of the particle size is not particularly limited.

A high-pressure disperser can also be used for the purpose of removing coarse particles or accelerating the dissolution. Examples of the high-pressure disperser include Gaulin (manufactured by A.P.V Gaulin Inc.), Nanomizer (manufactured by Nanomizer Inc.), Microfluidizer (manufactured by Microfluidex Inc.), Altimizer (manufactured by Sugino Machine Limited), and DeBee (manufactured by Bee International Ltd.). The particle size can be observed after scooping an organic solvent solution on a grid for electron microscopic observation and volatilizing the solvent.

### (Hydrophobilization Treatment)

As described above, in the case of using a polyanion dopant together with the electrically conductive polymer, it is preferable to subject the composition containing the electrically conductive polymer and the polyanion dopant to a hydrophobilization treatment. By applying a hydrophobilization treatment to the foregoing composition, the solubility of the electrically conductive polymer in an organic solvent can be enhanced, and the affinity with the polyfunctional monomer (B) having two or more polymerizable groups can be enhanced. The hydrophobilization treatment can be performed by modifying the anion group of the polyanion dopant.

Specifically, a first method of the hydrophobilization treatment includes a method of esterification, etherification, acetylation, tosylation, tritylation, alkysilylation, or alkylcarbonylation of the anion group. Above all, esterification and etherification are preferable. Examples of the method of performing the hydrophobilization by means of esterification include a method of chlorinating the anion group of the polyanion dopant with a chlorinating agent and then esterifying it with an alcohol such as methanol and ethanol. Also, the hydrophobilization can be performed by esterifying the anion group with a sulfo group or a carboxy group by using a compound having a hydroxyl group or a glycidyl group and further using a compound having an unsaturated double bonding group.

In the invention, conventionally known various methods can be adopted, and examples of these methods are specifically described in, for example, JP-A-2005-314671 and JP-2006-28439.

A second method of the hydrophobilization treatment includes a method of hydrophobilizing the anion group of the polyanion dopant by bonding a basic compound thereto. The basic compound is preferably an amine based compound, and examples thereof include a primary amine, a secondary amine, a tertiary amine, and an aromatic amine. Specific examples thereof include primary to tertiary amines substituted with an alkyl group having a carbon number of from 1 to 20 and imidazoles or pyridines substituted with an alkyl group having a carbon number of from 1 to 20. For the purpose of enhancing the solubility in an organic solvent, a molecular weight of the amine is preferably from 50 to 2,000, more preferably from 70 to 1,000, and most preferably from 80 to 500.

An amount of the amine compound that is a basic hydrophobilizing agent is preferably from 0.1 to 10.0 molar equivalents, more preferably from 0.5 to 2.0 molar equivalents, and especially preferably from 0.85 to 1.25 molar equivalents, relative to the anion group of the polyanion dopant which does not contribute to doping of the electrically conductive polymer. By allowing the amount of the amine compound to fall within this range, the solubility in an organic solvent, the electrical conductivity, and the strength of the coating film can be satisfied.

As for other details of the hydrophobilization treatment, the matters described in, for example, JP-A-2008-115215 and JP-A-2008-115216 can be applied.

### (Solubilization Aid)

The foregoing electrically conductive polymer can be used together with a compound containing a hydrophilic site, a hydrophobic site, and preferably an ionizing radiation-curable functional group-containing site in a molecule thereof (hereinafter referred to as a “solubilization aid”).

Use of a solubilization aid assists solubilization of the electrically conductive polymer in an organic solvent with a low water content and furthermore, makes it possible to improve a coated surface profile of a layer formed of the composition of the invention or increase the strength of the cured film.

The solubilization aid is preferably a copolymer having a hydrophilic site, a hydrophobic site, and an ionizing radiation-curable functional group-containing site, and especially preferably a block-type or graft-type copolymer in which these sites are divided into segments. Such a copolymer can be polymerized by living anionic polymerization or living radical polymerization, or by using macromonomers having the foregoing sites.

The solubilization aid is described in, for example, JP-A-2006-176681, paragraphs [0022] to [0038].

### (Preparation Method of Solution Containing Electrically Conductive Polymer)

The electrically conductive polymer can be prepared in the form of a solution by using the foregoing organic solvent.

Though a method for preparing a solution of the electrically conductive polymer includes several methods, the following three methods are preferable.

A first method is a method of polymerizing an electrically conductive polymer in water in the copresence of a polyanion dopant, optionally then treating the polymer by adding the foregoing solubilization aid or basic hydrophobilizing agent, and then replacing the water with an organic solvent. A second method is a method of polymerizing an electrically conductive polymer in water in the copresence of a polyanion dopant, optionally then treating the polymer with the foregoing solubilization aid or basic hydrophobilizing agent, evaporating the water to dryness, and then adding an organic solvent to solubilize the resulting polymer. A third method is a method of separately preparing a π-conjugated electrically conductive polymer and a polyanion dopant, then mixing and dispersing the both members in a solvent to prepare an electrically conductive polymer composition in a doped state, and in the case where the solvent contains water, replacing the water with an organic solvent.

In the foregoing methods, a use amount of the solubilization aid is preferably from 1 to 100% by mass, more preferably from 2 to 70% by mass, and most preferably from 5 to 50% by mass relative to a total amount of the electrically conductive polymer and the polyanion dopant. In the first method, the method of replacing the water with an organic solvent is preferably a method of preparing a uniform solution by adding and using a solvent having high miscibility with water, such as ethanol, isopropyl alcohol, and acetone, and then removing the water by means of ultrafiltration. Also, there is exemplified a method of reducing the water content to a certain extent by using a solvent having high miscibility with water, then mixing a more hydrophobic solvent, and removing highly volatile components under reduced pressure to prepare a solvent composition. Also, when sufficient hydrophobilization is performed using a basic hydrophobilizing agent, it is also possible to separate the composition into a two-phase system by adding an organic solvent with low miscibility with water and to extract the organic electrically conductive polymer into the organic solvent phase from the aqueous phase.

### [(B) Polyfunctional Monomer Having Two or More Polymerizable Unsaturated Groups]

In the invention, the composition contains (B) a polyfunctional monomer having two or more polymerizable groups (hereinafter also referred to as “polymerizable unsaturated groups”). This polyfunctional monomer (B) having two or more polymerizable unsaturated groups can function as a curing agent. By using a combination of (A) an electrically conductive polymer and (B) a polyfunctional monomer having two or more polymerizable unsaturated groups, it becomes possible to satisfy both the electrical conductivity and the strength or scratch resistance of the coating film. The number of polymerizable unsaturated groups is more preferably 3 or more.

Examples of the polyfunctional monomer having two or more polymerizable unsaturated groups, which is used in the invention, include compounds having a polymerizable functional group such as a (meth)acryloyl group, a vinyl group, a styryl group, an allyl group, and a —C(O)OCH═CH₂. Above all, any group selected from a substituted or unsubstituted acryloyl group, a substituted or unsubstituted methacryloyl group, and —C(O)OCH═CH₂ is preferable. The following compounds containing three or more (meth)acryloyl groups in one molecule thereof are especially preferable.

Specific examples of the compound having a polymerizable unsaturated bond include (meth)acrylic acid diesters of an alkylene glycol, (meth)acrylic acid diesters of a polyoxyalkylene glycol, (meth)acrylic acid diesters of a polyhydric alcohol, (meth)acrylic acid diesters of an ethylene oxide or propylene oxide adduct, epoxy (meth)acrylates, urethane (meth)acrylates, and polyester (meth)acrylates.

Of these, esters of a polyhydric alcohol and (meth)acrylic acid are preferable. Examples thereof include pentaerythritol tetra(meth)acrylate, pentaerythritol tri(meth)acrylate, trimethylolpropane tri(meth)acrylate, EO-modified trimethylolpropane tri(meth)acrylate, PO-modified trimethylolpropane tri(meth)acrylate, EO-modified phosphoric acid tri(meth)acrylate, trimethylolethane tri(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate, and caprolactone-modified tris(acryloxyethyl)isocyanurate.

As the polyfunctional acrylate based compounds having a (meth)acryloyl group, commercially available products can also be used, and examples thereof include KAYARAD DPHA and KAYARAD PET-30, all of which are manufactured by Nippon Kayaku Co., Ltd, A-TMMT, AD-TMP, all of which are manufactured by Shin-Nakamura Chemical Co., Ltd.

The non-fluorine-containing polyfunctional monomer is described in JP-A-2009-98658, paragraphs [0114] to [0122], and the same is applicable to the invention.

Also, from the viewpoints of an enhancement of the electrical conductivity and compatibility with the following compound (C), the foregoing polymerizable unsaturated group-containing compound is preferably a compound having a hydroxyl group.

From the standpoint of enhancing the electrical conductivity and the light resistance, the molecular weight of the compound having a polymerizable unsaturated bond is preferably 500 or less, more preferably 400 or less.

### [(C) Non-Aromatic Alcohol Compound Having Four or More Hydroxyl Groups]

The composition for antistatic layer of the invention contains (C) a non-aromatic alcohol compound having four or more hydroxyl groups.

The non-aromatic alcohol compound (C) having four or more hydroxyl groups as referred to in the invention indicates a compound having four or more hydroxyl groups, in which each of the hydroxyl groups is bound directly to a carbon atom, and the foregoing carbon atom does not participate in the π-conjugated system.

By allowing the non-aromatic alcohol compound (C) having four or more hydroxyl groups to contain in the composition containing the component (A) and the component (B), there is brought an effect for enhancing the electrical conductivity and durability.

The reasons why in view of the fact that non-aromatic alcohol compound (C) has four or more hydroxyl groups, excellent durability such as light resistance and excellent electrical conductivity can be achieved are not elucidated yet, but the following may be assumed.

That is, it may be considered that in view of the fact that the four or more hydroxyl groups which the non-aromatic alcohol compound (C) has form a hydrogen bond to the electrically conductive polymer (A), a distance between the electrically conductive polymer chains becomes short, so that the electrical conductivity and the durability are enhanced.

Also, since the non-aromatic alcohol compound (C) having four or more hydroxyl groups does not trap a radical at the time of polymerization, it does not inhibit the polymerization of the component (B), whereby high film strength can be achieved.

There is thus obtained an antistatic optical film which is excellent in all of film strength, durability such as light resistance, electrical conductivity, and transparency.

The non-aromatic alcohol compound (C) having four or more hydroxyl groups is not particularly limited so far as it does not have aromaticity and has four or more hydroxyl groups. From the viewpoint of compatibility with a curable binder, the hydroxyl group number is preferably from 4 to 25, more preferably from 4 to 10, and still more preferably from 4 to 6.

In the non-aromatic alcohol compound, in view of electrical conductivity and durability, the main chain structure is preferably linear, and from the standpoint that the linearity of the electrically conductive polymer chain is increased and, although the reasons is not clearly known, the electrical conductivity is considered to be more enhanced, it is preferred that the main chain structure is linear and at the same time, has a carbon number of 4 or more.

Here, the main chain structure indicates a longest carbon chain in the molecule of the non-aromatic alcohol compound (C), which may contain an atom (for example, an oxygen atom) other than a carbon atom, between carbon atoms.

The “linear” means a carbon chain which is not branched and in which carbon atoms are linearly bonded.

The upper limit of the carbon number of the main chain structure in the non-aromatic alcohol compound is not particularly limited but in the case of a low molecular compound, the upper limit is preferably 20 or less.

From the standpoint that, as described above, thanks to four or more hydroxyl groups, the distance between electrically conductive polymer chains is reduced and the electrical conductivity and durability are thereby enhanced, the density of hydroxyl groups in the non-aromatic alcohol compound is preferably high and within the above-described range of the number of hydroxyl groups, the hydroxyl group equivalent is preferably 50 or less, more preferably 40 or less. The lower limit of the hydroxyl group equivalent is not particularly limited but is usually 30 or more.

In the present invention, the hydroxyl group equivalent indicates the value obtained by dividing the molecular weight of the non-aromatic alcohol compound by the number of hydroxyl groups in the non-aromatic alcohol compound, and as the hydroxyl group equivalent of the compound is smaller, the distance between hydrogens in the non-aromatic alcohol compound is spatially shorter, so that “the hydroxyl group density is high” can result.

Specific examples of the compound having four or more hydroxyl groups include sugar alcohols such as erythritol, threitol, arabitol, xylitol, ribitol, iditol, galactitol, sorbitol, mannitol, allitol, volemitol, perseitol, D-erythro-D-galacto-octitol, and maltitol; cyclic polyhydric alcohols such as 1,2,3,5-cyclohexanetetraol, quercitol, inositol, inosamine, pentahydroxycyclohexanecarboxylic acid, and pentahydroxycyclohexanone; monosaccharides such as ribose, lyxose, xylose, arabinose, arose, talose, dalose, glucose, altrose, mannose, galactose, and idose; disaccharides; polysaccharides; sugar acids such as tartaric acid, glucaric acid, mannaric acid, and galactaric acid; pentaerythritol; dipentaerythritol; polyvinyl alcohol; diglycerol; and α-homonojirimycin.

The non-aromatic alcohol compound is preferably an aliphatic hydrocarbon compound having four or more hydroxyl groups at arbitrary positions (preferably having a carbon atom number of from 1 to 60), and in the aliphatic hydrocarbon compound, atoms other than the carbon atoms bound directly to the hydroxyl groups may be other atom than a carbon atom (for example, an oxygen atom, etc.).

The (C) non-aromatic alcohol compound having 4 or more hydroxyl groups is preferably contained in an amount of 0.1 to 5 mass %, more preferably from 0.2 to 4.5 mass %, still more preferably from 0.5 to 3.5 mass %, based on the solid matters contained in the antistatic layer. If the amount added is less than 0.1 mass %, the desired performances are not brought out, whereas if the compound is added in excess of 5 mass %, the film may turn white turbid.

### [Other Additives]

—Dopant—

From the viewpoint that the dispersibility in a solvent at the preparation of a composition for forming the antistatic layer of the invention is improved, it is preferable that the antistatic layer of the invention contains at least one kind of a dopant. The antistatic layer is preferably formed by coating as described later, and from the viewpoint of manufacture, it is important to obtain a liquid dispersion (composition) with favorable dispersibility. Incidentally, the “dopant” as referred to in the invention means an additive having an action of changing the electrical conductivity of the electrically conductive polymer. Examples of such a dopant include an electron accepting (acceptor) dopant and an electron donating (donor) dopant.

Examples of the electron accepting (acceptor) dopant include a halogen (for example, Cl₂, Br₂, I₂, ICl, ICl₃, IBr, IF, etc.), a Lewis acid (for example, PF₅, AsF₅, SbF₅, BF₃, BCl₃, BBr₃, SO₃, etc.), a protonic acid (for example, HF, HCl, HNO₃, H₂SO₄, HClO₄, FSO₃H, ClSO₃H, CF₃SO₃H, various organic acids, amino acids, etc.), a transition metal compound (for example, FeCl₃, FeOCl, TiCl₄, ZrCl₄, HfCl₄, NbF₅, NbCl₅, TaCl₅, MoF₅, MoCl₅, WF₆, WCl₆, UF₆, LnCl₃ (Ln is a lanthanide such as La, Ce, Pr, Nd, and Sm), an electrolyte anion (for example, Cl⁻, Br⁻, I⁻, ClO₄⁻, PF₆⁻, AsF₆⁻, SbF₆⁻, various sulfonate anions, etc.), O₂, XeOF₄, (NO₂⁻, BF₄⁺)(SbF₆⁻), (NO₂⁺)(SbCl₆⁻), (NO₂⁺)(BF₄⁻), FSO₂OOSO₂F, AgClO₄, H₂IrCl₆, and La(NO₃)₃.6H₂O.

Examples of the electron donating (donor) dopant include an alkali metal (for example, Li, Na, K, Rb, Cs, etc.), an alkaline earth metal (for example, Ca, Sr, Ba, etc.), a lanthanide (for example, Eu, etc.), and others (for example, R₄N⁺, R₄P⁺, R₄As⁺, R₃S⁺, acetylcholine, etc., wherein R is a substituted or unsubstituted hydrocarbon group).

Examples of a combination of the dopant and the electrically conductive polymer include the following combinations (A) to (K).

(A) A combination of polyacetylene with I₂, AsF₅, FeCl₃, etc.

(B) A combination of poly(p-phenylene) with AsF₅, K, AsF₆⁻, etc.

(C) A combination of polypyrrole with ClO₄⁻, etc.

(D) A combination of a polythiophene with ClO₄⁻, a sulfonic acid compound, particularly polystyrenesulfonic acid, a nitrosonium salt, an aminium salt, a quinone, etc.

(E) A combination of polyisothianaphthene with I₂, etc.

(F) A combination of poly(p-phenylene sulfide) with AsF₅

(G) A combination of polyp-phenylene oxide) with AsF₅

(H) A combination of polyaniline with HCl, dodecylbenzenesulfonic acid, etc.

(I) A combination of poly(p-phenylenevinylene) with H₂SO₄, etc.

(J) A combination of polythiophenylenevinylene with I₂, etc.

(K) A combination of nickel phthalocyanine with I₂, etc.

Among these combinations, the combinations (D) and (H) are preferable; the combination of a polythiophene (for example, polythiophene and its derivatives) with a sulfonic acid compound is more preferable from the viewpoint of high stability of the doped state; and the combination of a polythiophene with a polystyrenesulfonic acid is still more preferable from the viewpoints that a water dispersion can be prepared and that an electrically conductive thin film can be easily prepared by coating.

Though a ratio between the electrically conductive polymer and the dopant may be any ratio, from the viewpoint of satisfying both the stability of doped state and the electrical conductivity, a ratio of the electrically conductive polymer to the dopant is preferably in the range of from 1.0/0.0000001 to 1.0/10, more preferably in the range of from 1.0/0.00001 to 1.0/1.0, and still more preferably in the range of from 1.0/0.0001 to 1.0/0.5 in terms of mass ratio.

On the other hand, in order to enhance the dispersibility of the electrically conductive polymer, an ion conductive polymer prepared by doping an electrolyte into a polymer chain may be used. Examples of the polymer chain include a polyether (for example, polyethylene oxide, polypropylene oxide, etc.), a polyester (for example, polyethylene succinate, poly-β-propiolactone, etc.), a polyamine (for example, polyethyleneimine, etc.), and a polysulfide (for example, a polyalkylene sulfide, etc.). Examples of the doped electrolyte include various alkali metal salts.

Examples of the alkali metal ion constituting the alkali metal salt include Li⁺, Na⁺, K⁺, Rb⁺, and Cs⁺, and examples of the anion forming a counter salt include F⁻, Cl⁻, Br⁻, I⁻, NO₃⁻, SCN⁻, ClO₄⁻, CF₃SO₃⁻, BF₄⁻, AsF₆⁻, and BPh₄⁻.

Examples of the combination of the polymer chain and the alkali metal salt include a combination of polyethylene oxide with LiCF₃SO₃, LiClO₄, etc., a combination of polyethylene succinate with LiClO₄, LiBF₄, etc., a combination of poly-β-propiolactone with LiClO₄, etc., a combination of polyethyleneimine with NaCF₃SO₃, LiBF₄, etc., and a combination of a polyalkylene sulfide with AgNO₃, etc.

### [(D) Photopolymerization Initiator]

The composition for forming the antistatic layer in the invention preferably contains a photopolymerization initiator.

Examples of the photopolymerization initiator include acetophenones, benzoins, benzophenones, phosphine oxides, ketals, anthraquinones, thioxanthones, azo compounds, peroxides, 2,3-dialkyldione compounds, disulfide compounds, fluoroamine compounds, aromatic sulfoniums, lophine dimers, onium salts, borate salts, active esters, active halogens, inorganic complexes, and coumarins. Specific examples, preferred embodiments and commercial products of the photopolymerization initiator are described in JPA-2009-098658, paragraphs [0133] to [0151], and these can also be suitably used in the invention.

Various examples are also described in Saishin UV Koka Gijutsu (Latest UV Curing Technology), Technical Information Institute Co., Ltd., page 159 (1991), and Kiyomi Kato, Shigaisen Koka System (Ultraviolet Curing System), Sogo Gijutsu Center, pages 65 to 148 (1989), and these are useful in the invention.

### (Surfactant)

It is preferable to use a surfactant of every sort in the antistatic layer of the invention. In general, a surfactant is added for the purpose of suppressing the film thickness unevenness or the like to be caused due to scattering in drying by local distribution of drying air. In the invention, in addition to the foregoing effect, it has been noted that surface unevenness of the antistatic layer or repellency of the coated material, which may be considered to be attributable to the compatibility of materials, can be improved. In particular, when the component (C) is added so as to improve the durability such as light resistance, there may be the case where the surface of the coating film is roughened. However, this can be suppressed by using a surfactant in combination, and it becomes possible to satisfy both the electrical conductivity and the durability at a high level.

Specifically, the surfactant is preferably a fluorine based surfactant or a silicone based surfactant. Also, the surfactant is preferably an oligomer or a polymer rather than a low molecular compound.

When a surfactant is added, the surfactant rapidly moves and is unevenly distributed to the surface of the coated liquid film, and the surfactant remains unevenly distributed to the surface after drying the film. As a result, the surface energy of the antistatic layer to which the surfactant is added is lowered by the surfactant. From the viewpoint of preventing non-uniformity in film thickness, repellency, or unevenness of the antistatic layer from occurring, it is preferable that the surface energy of the film is low.

The surface energy (γs^{v}, unit: mJ/m²) of the layer can be experimentally determined using pure water H₂O and methylene iodide CH₂I₂ on the layer by reference to D. K. Owens, J. Appl. Polym. Sci., Vol. 13, page 1741 (1969). At that time, assuming that the contact angles with pure water and methylene iodide are θ_{H2O} and θ_{CH212}, respectively, γs^{d} and γs^{h} are obtained according to the following simultaneous equations (1) and (2), and from the value γs^{v} (=γs^{d}+γs^{h}) as the sum thereof, an energy-reduced value (a value obtained by converting the mN/m unit into an mJ/m² unit) of a surface tension of an antiglare layer is determined and defined as the surface energy. Before the measurement, a sample needs to be subjected to humidity conditioning under a predetermined temperature and humidity condition for a fixed time or more. On that occasion, the temperature is preferably in the range of from 20° C. to 27° C., the humidity is preferably in the range from 50 to 65 RH %, and the humidity conditioning time is preferably 2 hours or more.

1+cos θ_{H2O}=2√γs^{d}(√γ_{H2O}^{d}/γ_{H2O}^{v})+2√γs^{h}(√γ_{H2O}^{h}/γ_{H2O}^{v}) (1)

1+cos θ_{CH212}=2√γs^{d}(√γ_{CH212}^{d}/γ_{CH212}^{v})+2√γs^{h}(√γ_{CH212}^{h}/γ_{CH212}^{v}) (2)

Here, γ_{H2O}^{d}=21.8°, γ_{H2O}^{h}=51.0°, γ_{H2O}^{v}=72.8°, γ_{CH212}^{d}=49.5°, γ_{CH212}^{h}=1.3°, γ_{CH212}^{v}=50.8°

The surface energy of the antistatic layer is preferably in the range of not more than 45 mJ/m², more preferably in the range of from 20 to 45 mJ/m², and still more preferably in the range of from 20 to 40 mJ/m². By regulating the surface energy of the layer to not more than 45 mJ/m², an effect such as unification of the film thickness or an improvement of repellency on the antistatic layer can be obtained. However, in the case of further coating an upper layer such as a low refractive index layer on the layer to which the surfactant is added, the surfactant is preferably a surfactant capable of eluting and moving into the upper layer, and the surface energy of the surfactant-added layer after immersion and washing of the layer with the solvent (for example, methyl ethyl ketone, methyl isobutyl ketone, toluene, cyclohexanone, etc.) of the coating solution for the upper layer is preferably rather higher. The surface energy is preferably from 35 to 70 mJ/m².

Preferred embodiments and specific examples of the fluorine based surfactant are described in JP-A-2007-102206, paragraphs [0023] to [0080], and the same is applicable to the invention.

Preferred examples of the silicone based compound include those having a substituent at the terminal and/or in the side chain of a compound chain containing a plurality of dimethylsilyloxy units as the repeating unit. The compound chain containing dimethylsilyloxy as the repeating unit may contain a structural unit other than dimethylsilyloxy. Each substituent may be the same as or different from every other substituent, and it is preferable that a plurality of substituents are present. Preferred examples of the substituent include groups containing a polyether group, an alkyl group, an aryl group, an aryloxy group, an acryloyl group, a methacryloyl group, a vinyl group, an aryl group, a cinnamoyl group, an epoxy group, an oxetanyl group, a hydroxyl group, a fluoroalkyl group, a polyoxyalkylene group, a carboxyl group, or an amino group.

Though the molecular weight is not particularly limited, it is preferably not more than 100,000, more preferably not more than 50,000, especially preferably from 1,000 to 30,000, and most preferably from 1,000 to 20,000.

Though a content of the silicon atom content of the silicone based compound is not particularly limited, it is preferably 18.0% by mass or more, especially preferably from 25.0 to 37.8% by mass, and most preferably from 30.0 to 37.0% by mass.

Preferred examples of the silicon based compound include “X-22-174DX”, “X-22-2426”, “X-22-164B”, “X22-164C”, “X-22-170DX”, “X-22-176D”, and “X-22-1821” (all of which are a trade name), manufactured by Shin-Etsu Chemical Co., Ltd.; “FM-0725”, “FM-7725”, “FM-4421”, “FM-5521”, “FM-6621”, and “FM-1121” (all of which are a trade name), manufactured by Chisso Corporation; “DMS-U22”, “RMS-033”, “RMS-083”, “UMS-182”, “DMS-H21”, “DMS-H31”, “HMS-301”, “FMS121”, “FMS123”, “FMS131”, “FMS141”, and “FMS221” (all of which are a trade name), manufactured by Gelest; “SH200”, “DC11PA”, “SH28PA”, “ST80PA”, “ST86PA”, “ST97PA, “SH550”, “SH710”, “L7604”, “FZ-2105”, “FZ2123”, “FZ2162”, “FZ-2191”, “FZ2203”, “FZ-2207”, “FZ-3704”, “FZ-3736”, “FZ-3501”, “FZ-3789”, “L-77”, “L-720”, “L-7001”, “L-7002”, “L-7604”, “Y-7006”, “SS-2801”, “SS-2802”, “SS-2803”, “SS-2804”, and “SS-2805” (all of which are a trade name), manufactured by Dow Corning Toray Co., Ltd.; and “TSF400”, “TSF401”, “TSF410”, “TSF433”, “TSF4450”, and “TSF4460” (all of which are a trade name), manufactured by Momentive Performance Materials Inc. However, it should not be construed that the invention is limited thereto.

—Translucent Particle—

In the antistatic layer of the invention, various translucent particles can be used for the purpose of imparting antiglare properties (surface scattering properties) or internal scattering properties.

The translucent particle may be either an organic particle or an inorganic particle. A smaller variation in the particle diameter leads to a smaller variation in the scattering properties and makes it easy to design a haze value. The translucent particle is suitably a plastic bead, and in particular, a plastic bead having high transparency and giving the above-described numerical value as a difference in refractive index from the binder is preferable.

Examples of the organic particle used include a polymethyl methacrylate particle (refractive index: 1.49), a crosslinked poly(acryl-styrene) copolymer particle (refractive index: 1.54), a melamine resin particle (refractive index: 1.57), a polycarbonate particle (refractive index: 1.57), a polystyrene particle (refractive index: 1.60), a crosslinked polystyrene particle (refractive index: 1.61), a polyvinyl chloride particle (refractive index: 1.60), and a benzoguanamine-melamine formaldehyde particle (refractive index: 1.68).

Examples of the inorganic particle include a silica particle (refractive index: 1.44), an alumina particle (refractive index: 1.63), a zirconia particle, a titania particle, and a hollow or porous inorganic particle.

Among these, a crosslinked polystyrene particle, a crosslinked poly((meth)acrylate) particle, and a crosslinked poly(acryl-styrene) particle are preferably used. By adjusting the refractive index of the binder in conformity with the refractive index of the respective translucent particle selected from these particles, an internal haze, a surface haze, and a centerline average roughness of the invention can be achieved.

Furthermore, it is preferable to use a combination of a binder composed mainly of a trifunctional or polyfunctional (meth)acrylate monomer (refractive index after curing: from 1.50 to 1.53) and a translucent particle composed of a crosslinked poly(meth)acrylate polymer having an acryl content of from 50 to 100% by weight. In particular, a combination of the binder and a translucent particle composed of a crosslinked poly(styrene-acryl) copolymer (refractive index: from 1.48 to 1.54) is preferable.

The refractive index of the binder component (in which a component other than a translucent particle is mixed) and the translucent particle is preferably from 1.45 to 1.70, and more preferably from 1.48 to 1.65.

Also, in the invention, a difference in refractive index between the binder and the translucent particle ((refractive index of translucent particle)−(refractive index of binder)) is preferably from 0.001 to 0.030, more preferably from 0.001 to 0.020, and still more preferably from 0.001 to 0.015 in terms of an absolute value. When this difference exceeds 0.030, there is caused a problem such as film character blurring, reduction in dark-room contrast, or surface clouding. In order that the difference in refractive index may fall within the foregoing range, the binder and the translucent particle may be appropriately selected with respect to the kind and amount proportion. How to select can be experimentally easily known in advance.

Here, the refractive index of the binder can be quantitatively evaluated by directly measuring the refractive index by an Abbe refractometer or by measuring a spectral reflection spectrum or a spectral ellipsometry. The refractive index of the translucent particle is determined as follows. The translucent particle is dispersed in an equal amount in solvents prepared by changing a mixing ratio of two kinds of solvents having a different refractive index from each other to vary the refractive index, a turbidity is measured, and the refractive index of the solvent when the turbidity becomes minimum is measured by an Abbe refractometer.

In the case of the foregoing translucent particle, the translucent particle is liable to precipitate in the binder, and therefore, an inorganic filler such as silica may be added for the purpose of preventing precipitation from occurring. Incidentally, the more increased the addition amount of the inorganic filler, the more effective the prevention of precipitation of the translucent particle from occurring. However, the transparency of the coating film is adversely affected. Accordingly, an inorganic filler having a particle diameter of not more than 0.5 μm may be preferably allowed to contain in the binder in an amount of less than about 0.1% by mass to such an extent that the transparency of the coating film is not impaired.

An average particle diameter (on the volume basis) of the translucent particle is preferably from 0.5 to 20 μm, and more preferably from 2.0 to 15.0 μm. What the average particle diameter is less than 0.5 μm is not preferable because the distribution of light scattering angle extends to a wide angle, and blurring of characters on the display is likely caused. On the other hand, when it exceeds 20 μm, the film thickness of the layer to which the translucent particle is added is required to be increased, thereby causing a problem such as curl or an increase in costs.

Also, two or more kinds of translucent particles having a different particle diameter from each other may be used in combination. Antiglare properties may be imparted by the translucent particle having a larger particle diameter may impart, and a roughened texture on the surface may be reduced by the translucent particle having a smaller particle diameter.

The translucent particle is blended so as to account for from 3 to 30% by mass, and preferably from 5 to 20% by mass in the whole of solids of the layer to which the translucent particle is added. When the content of the translucent particle is less than 3% by mass, the effect to be brought by the addition is insufficient, whereas when it exceeds 30% by mass, there is caused a problem such as blurring of the image or clouding or glaring of the surface.

Also, a density of the translucent particle is preferably from 10 to 1,000 mg/m², and more preferably from 100 to 700 mg/m².

The antistatic layer of the invention may further contain a solvent as described later or other additives. Examples of the additive which can be further added include: a UV absorber, a phosphorous acid ester, hydroxamic acid, a hydroxyamine, an imidazole, hydroquinone, and phthalic acid, for the purpose of suppressing decomposition of the polymer; an inorganic fine particle, a polymer fine particle, and a silane coupling agent, for the purpose of increasing the film strength; and a fluorine based compound (particularly a fluorine based surfactant) for the purpose of reducing the refractive index and increasing the transparency.

### [Composition for Antistatic Layer]

The composition for antistatic layer in the invention contains (A) an electrically conductive polymer, (B) a polyfunctional monomer having two or more polymerizable groups, (C) a non-aromatic alcohol compound having four or more hydroxyl groups, and (D) a photopolymerization initiator, and optionally, other additives.

A preferred content of each of the components in the coating composition for forming the antistatic layer is described below. Incidentally, the “content” as referred to herein indicates a ratio (% by mass) of the solid content of each of the components to the whole of solids in the coating composition.

A content of the component (A) is preferably from 0.1 to 20% by mass, more preferably from 0.1 to 12% by mass, and most preferably from 0.2 to 5% by mass.

A content of the component (B) is preferably from 60 to 99% by mass, more preferably from 75 to 99% by mass, and most preferably from 85 to 97% by mass.

A content of the component (C) is preferably from 0.1 to 10% by mass, more preferably from 0.1 to 5% by mass, and most preferably from 0.1 to 2% by mass.

Though a ratio of the non-aromatic alcohol compound and the electrically conductive polymer in the composition for antistatic layer in the invention may be any ratio, from the viewpoint of satisfying both high antistatic properties and high durability, a ratio of the non-aromatic alcohol compound to the electrically conductive polymer is preferably in the range of from 0.01/1.0 to 10/1, more preferably in the range of from 0.05/1.0 to 5.0/0.1, and still more preferably in the range of from 0.05/1.0 to 1.0/1.0 in terms of a mass ratio.

A content of the component (D) is preferably from 1 to 10% by mass, and more preferably from 1 to 5% by mass.

When the content of the component (A) is less than 0.1% by mass, the electrical conductivity is low, and a sufficient antistatic effect cannot be obtained, whereas when it exceeds 20% by mass, the film strength becomes weak, or the coating film is colored, leading to a reduction in the transmittance.

When the content of the component (B) is less than 50% by mass, the strength of the coating film may become weak.

When the content of the component (C) is less than 0.1% by mass, the effect of improving the durability such as light resistance and the electrical conductivity cannot be obtained, whereas when it exceeds 10% by mass, deterioration of the surface profile may result, such as whitening of the coating film due to bleeding and generation of surface unevenness on the coating film.

In the case where the coating composition contains a solvent, the solvent is used in such a manner that the concentration of solids in the coating composition is in the range of preferably from 1 to 70% by mass, more preferably from 3 to 60% by mass, and most preferably from 40 to 60% by mass.

### [Antistatic Layer]

A refractive index of the antistatic layer in the invention is preferably from 1.48 to 1.65, more preferably from 1.48 to 1.60, and most preferably from 1.48 to 1.55. What the refractive index falls within the foregoing range is preferable because interference unevenness with the base material can be suppressed, and at the time when a low refractive index layer is stacked, a reflected tint can be made neutral.

A film thickness of the antistatic layer is preferably from 0.05 to 20 μm, more preferably from 2 to 15 μm, and most preferably from 5 to 10 μm. By allowing the film thickness of the antistatic layer to fall within the foregoing range, both the physical strength and the electrical conductivity can be satisfied.

A transmittance of the antistatic layer is preferably 80% or more, more preferably 85% or more, and most preferably 90% or more.

In the case where the antistatic layer does not contain a resin particle for imparting the antiglare properties, a haze of the antistatic layer is preferably not more than 3%, more preferably not more than 2%, and most preferably not more than 1%. On the other hand, in the case where the antistatic layer contains a resin particle for the purpose of imparting the antiglare properties, a haze of the antistatic layer is preferably from 0.1 to 30%, and more preferably from 0.1 to 20%.

### [Optical Film]

A hardness of the optical film of the invention is 3H or more in a pencil hardness test with a load of 500 g.

A common logarithmic value (log SR) of a surface resistivity SR (Ω/sq) of the optical film of the invention is preferably not more than 13, more preferably from 5 to 12, and still more preferably from 7 to 11. By allowing the surface resistivity to fall within the foregoing range, excellent dust-proof performance and surface profile can be imparted.

In order to obtain such a surface resistivity, a content of the electrically conductive polymer (A) in the antistatic layer is preferably from 0.01 to 1.0 g/m², more preferably from 0.05 to 0.5 g/m², and still more preferably from 0.1 to 0.3 g/m².

### [Manufacturing Method of Optical Film]

The optical film of the invention can be formed by the following method, but it should not be construed that the invention is limited to this method. First of all, a composition for antistatic layer is prepared. Subsequently, the composition is coated on a transparent support by a dip coating method, an air knife coating method, a curtain coating method, a roller coating method, a wire bar coating method, a gravure coating method, a die coating method, or the like, followed by heating/drying. A microgravure coating method, a wire bar coating method, and a die coating method (see, U.S. Pat. No. 2,681,294 and JP-A-2006-122889) are more preferable, with a die coating method being especially preferable.

After coating, the layer formed of the coating composition can be cured upon irradiation with light. There is thus formed an antistatic layer. If desired, after other layers (for example, layers constituting the film as described later, such as a hard coat layer and an antiglare layer) are previously coated on a transparent support, the antistatic layer can be formed thereon. In this way, the optical film of the invention can be obtained.

### [Layer Configuration of Optical Film]

The optical film of the invention can be fabricated by providing an antistatic layer and a single or a plurality of functional layers required depending upon the purpose on a transparent support. As to the optical film, there can be exemplified an optical film having a hard coat layer for the purpose of increasing the physical strength of the optical film; and an optical film in which layers are stacked by taking a refractive index, a film thickness, a number of layers, an order of layers, and the like into consideration so as to reduce a reflectance by optical interference.

Incidentally, other functions may be added to the antistatic layer of the invention. For example, an antistatic layer serving also as a low refractive index layer may be formed by adding a compound working so as to have a low refractive index. In order to impart low refractive index properties to the antistatic layer in the invention, the configuration of a “low refractive index layer” as described later can be applied. In addition to the above, hard coat properties or antiglare properties can be imparted to the antistatic layer of the invention.

Specific examples of the layer configuration of the optical film of the invention are set forth below.

Transparent support/antistatic layer

Transparent support/antistatic layer/low refractive index layer

Transparent support/hard coat layer/antistatic layer

Transparent support/antistatic layer/hard coat layer

Transparent support/antiglare layer/antistatic layer

Transparent support/antistatic layer/antiglare layer

Transparent support/antistatic layer/high refractive index layer/low refractive index layer

Transparent support/antistatic layer/medium refractive index layer/high refractive index layer/low refractive index layer

Transparent support/antistatic layer/hard coat layer/low refractive index layer

Transparent support/hard coat layer/antistatic layer/low refractive index layer

Transparent support/antiglare layer/antistatic layer/low refractive index layer

Transparent support/antistatic layer/antiglare layer/low refractive index layer

Transparent support/hard coat layer/antistatic layer/medium refractive index layer/high refractive index layer/low refractive index layer

Transparent support/antistatic layer/hard coat layer/medium refractive index layer/high refractive index layer/low refractive index layer

### (Transparent Support)

The transparent support in the optical film of the invention is preferably a transparent base material film. The transparent base material film is not particularly limited, and examples thereof include a transparent resin film, a transparent resin plate, a transparent resin sheet, and a transparent glass. Examples of the transparent resin film include a cellulose acylate film (for example, a cellulose triacetate film (refractive index: 1.48), a cellulose diacetate film, a cellulose acetate butyrate film, a cellulose acetate propionate film, etc.), a polyethylene terephthalate film, a polyethersulfone film, a polyacrylic resin film, a polyurethane based resin film, a polyester film, a polycarbonate film, a polysulfone film, a polyether film, a polymethylpentene film, a polyether ketone film, a (meth)acrylonitrile film, a polyolefin, and a polymer having an alicyclic structure (for example, a norbornene based resin (ARTON, a trade name, manufactured by JSR Corporation), an amorphous polyolefin (ZEONEX, a trade name, manufactured by Zeon Corporation), etc.). Among these, triacetyl cellulose, polyethylene terephthalate, and a polymer having an alicyclic structure are preferable, with triacetyl cellulose being especially preferable.

In general, though a transparent support having a thickness of from about 25 μm to 1,000 μm can be used, the thickness is preferably from 25 μm to 250 μm, and more preferably from 30 μm to 90 μm.

The surface of the transparent support is preferably smooth and preferably has an average roughness Ra value of not more than 1 μm. The average roughness value is more preferably from 0.0001 to 0.5 μm, and still more preferably from 0.001 to 0.1 μm.

The transparent support is described in JP-A-2009-98658, paragraphs [0163] to [0169], and the same can be applied to the invention.

### (Hard Coat Layer)

In the optical film of the invention, a hard coat layer can be provided for the purpose of imparting the physical strength of the film. In the invention, though a hard coat layer may not be provided, it is preferable to provide a hard coat layer because the scratch resistance of the surface subjected to a pencil scratch test or the like is increased.

From the standpoint of optical design to obtain an antireflection performance, a refractive index of the hard coat layer in the invention is preferably from 1.48 to 1.65, more preferably from 1.48 to 1.60, and most preferably from 1.48 to 1.55.

From the viewpoint of imparting sufficient durability and impact resistance to the film, a film thickness of the hard coat layer is from 0.5 μm to 20 μm, preferably from 1 μm to 10 μm, and more preferably from 1 μm to 5 μm.

Also, it is preferable that the strength of the hard coat layer is 3H or more in a pencil hardness test. Furthermore, it is preferable that in a taber test in conformity with JIS K5400, an abrasion loss of a specimen before and after the test is as small as possible.

As a binder component for forming the hard coat layer, the monomers described above with respect to the polyfunctional monomer (B) having two or more polymerizable unsaturated groups can be suitably used.

For the purpose of imparting internal scattering properties, the hard coat layer may contain a matte particle, for example, an inorganic compound particle or a resin particle, having an average particle diameter of from 1.0 to 10.0 μm, and preferably from 1.5 to 7.0 μm.

For the purpose of controlling the refractive index of the hard coat layer, monomers or inorganic particles having various refractive indexes, or both of them, can be added to the binder of the hard coat layer. The inorganic particle has an effect of suppressing curing shrinkage due to a crosslinking reaction, in addition to the effect of controlling the refractive index. The binder as referred to in the invention is a binder inclusive of a polymer produced by the polymerization of, for example, the foregoing polyfunctional monomer and/or high refractive index monomer after the formation of the hard coat layer, and inorganic particles dispersed therein. Use of a silica fine particle as the inorganic particle for controlling the refractive index is preferable from the viewpoint of suppressing the tint unevenness to be caused due to interference between the support and the hard coat layer.

### (Antiglare Layer)

In the invention, separately from the antistatic layer, an antiglare layer may be formed for the purpose of imparting, to the film, antiglare properties thanks to surface scattering and hard coat properties for enhancing preferably hardness and scratch resistance of the film.

The antiglare layer is described in JP-A-2009-98658, paragraphs [0178] to [0189], and the same can be applied to the invention.

### (High Refractive Index Layer and Medium Refractive Index Layer)

As described above, a refractive index of the high refractive index layer is preferably from 1.65 to 2.20, and more preferably from 1.70 to 1.80. A refractive index of the medium refractive index layer is adjusted to a value between a refractive index of the low refractive index layer and a refractive index of the high refractive index layer. The refractive index of the medium refractive index layer is preferably from 1.55 to 1.65, and more preferably from 1.58 to 1.63.

As for a method of forming the high refractive index layer and the medium refractive index layer, a transparent thin film of an inorganic oxide formed by a chemical vapor deposition (CVD) method or a physical vapor deposition (PVD) method, particularly a vacuum vapor deposition method or a sputtering method, each of which is a kind of the physical vapor deposition method, can be adopted, but a method by all-wet coating is preferable.

Though the medium refractive index layer and high refractive index layer are not particularly limited so far as they are a layer having a refractive index falling within the foregoing range, those known as the constituent component can be used, and specific examples thereof are described in JP-A-2008-262187, paragraphs [0074] to [0094].

### (Low Refractive Index Layer)

It is preferable that the optical film of the invention has a low refractive index layer on the antistatic layer directly or via other layer. In that case, the optical film of the invention can function as an antireflection film.

In that case, a refractive index of the low refractive index layer is preferably from 1.30 to 1.51, more preferably from 1.30 to 1.46, and still more preferably from 1.32 to 1.38. What the refractive index of the low refractive index layer is allowed to fall within the foregoing range is preferable because the reflectance can be kept low, and the film strength can be maintained. As for a method of forming the low refractive index layer, a transparent thin film of an inorganic oxide formed by a chemical vapor deposition (CVD) method or a physical vapor deposition (PVD) method, particularly a vacuum vapor deposition method or a sputtering method, each of which is a kind of the physical vapor deposition method, can also be adopted, but it is preferable to adopt a method by all-wet coating using a composition for low refractive index layer.

Though the low refractive index layer is not particularly limited so far as it is a layer having a refractive index falling within the foregoing range, those known as the constituent component can be adopted. Specifically, a composition containing a fluorine-containing curable resin and an inorganic fine particle described in JP-A-2007-298974 and a hollow silica fine particle-containing low refractive index coating described in JP-A-2002-317152, JP-A-2003-202406, and JP-A-2003-292831 can be suitably used.

Among those examples of the layer configuration, the optical film of the invention preferably has a configuration where two layers of hard coat layer (antiglare layer)/antistatic layer are stacked on a transparent support. On that occasion, a low refractive index layer and the like may be provided on the antistatic layer. Furthermore, it is preferable to adopt a method in which the foregoing two layers are formed by simultaneously coating and forming two coated layers in one coating step.

When the film thickness of the antistatic layer is increased so as to obtain high hard coat properties while keeping the electrically conductive polymer content in the layer constant, a total amount of the electrically conductive polymer in the layer is increased, and therefore, there is a tendency that the coloration becomes strong, and the transmittance is lowered. Also, when the film thickness is increased, the electrically conductive polymer present in a lower part of the layer does not contribute to the effect of decreasing the surface resistance, and therefore, the use amount of the electrically conductive polymer becomes large. Thanks to the foregoing two-layer configuration of a hard coat layer (antiglare layer) and an antistatic layer containing an electrically conductive polymer in a high density, an optical film satisfying all of high hard coat properties, electrical conductivity and transmittance can be obtained.

On that occasion, by simultaneously coating and forming two layers of the hard coat layer and the antistatic layer in one coating step, it becomes possible to achieve high productivity with a low cost. As a method for simultaneously forming two layer in one coating step, a known method can be adopted. Specifically, a method described in, for example, JP-A-2007-293302, paragraphs [0032] to [0056], can be utilized.

### [Protective Film for Polarizing Plate]

In the case of using the optical film as a surface protective film of a polarizing film (protective film for polarizing plate), the adhesion to the polarizing film composed mainly of polyvinyl alcohol can be improved by hydrophilizing a surface of the transparent support on an opposite side to having a thin film layer, namely, a surface on the side to be stuck with the polarizing film.

It is also preferable that of two protective films of a polarizer, the film other than the optical film is an optically compensatory film having an optically compensatory layer containing an optically anisotropic layer. The optically compensatory film (retardation film) can improve viewing angle characteristics on a liquid crystal display screen.

Though a known optically compensatory film can be used from the standpoint of enlarging a viewing angle, an optically compensatory film described in JP-A-2001-100042 is preferable.

In the case of using the optical film as a surface protective film of a polarizing film (protective film for polarizing plate), it is especially preferable to use a triacetyl cellulose film as the transparent support.

Examples of a method for fabricating the protective film for polarizing plate in the invention include three methods of (1) a method of coating respective layers constituting the antireflection film on one surface of a transparent support which is previously subjected to a saponification treatment; (2) a method of coating an antireflection layer on one surface of a transparent support and then applying a saponification treatment to a side thereof on which a polarizing film is stuck or both surfaces thereof; and (3) a method of coating a part of an antireflection layer on one surface of a transparent support, applying a saponification treatment to a side thereof on which a polarizing film is stuck or both surfaces thereof, and then coating the remaining layer. In the method (1), the surface on the antireflection layer is to be coated is also hydrophilized, thereby making it difficult to ensure the adhesion between the transparent support and the antireflection layer, and therefore, the method (2) is especially preferable.

### [Polarizing Plate]

Next, a polarizing plate of the invention is described below. The polarizing plate of the invention is a polarizing plate comprising a polarizing film and two protective films for protecting both surfaces of the polarizing film, wherein at least one of the protective films is the antireflection film of the present invention.

A configuration where the transparent support of the optical film is allowed to adhere to a polarizing film optionally via an adhesive layer made of a polyvinyl alcohol, and a protective film is also provided on the other side of the polarizing film is preferable. On the surface of the other protective film opposite to the polarizing film, a pressure-sensitive adhesive layer may be provided.

By using the optical film of the invention as a protective film for polarizing plate, a polarizing plate which is excellent in physical strength, antistatic properties, and durability can be fabricated.

Also, the polarizing plate of the invention can also have an optically compensating function. In that case, it is preferable that the surface protective film only on one surface side of either the front surface or the back surface is formed using the foregoing optical film, and the surface protective film on the surface of the polarizing plate on the side opposite to the side having the optical film of the polarizing plate is an optically compensatory film.

By fabricating a polarizing plate where the optical film of the invention is used for one of the protective films for polarizing plate, and an optically compensatory film having optical anisotropy is used for the other protective film of the polarizing film, the contrast in a bright room and the up/down right/left viewing angle of a liquid crystal display device can be improved.

Also, an image display device of the invention comprises the antireflection film or polarizing plate of the invention on an outermost surface of the display.

### EXAMPLES

The invention is described below in more detail by reference to the following Examples, but it should not be construed that the scope of the invention is limited thereto. Incidentally, all “parts” and “%” are on the mass basis unless otherwise indicated.

### Example 1

### Preparation Example 1-1

### Preparation of Aqueous Solution (A) of Electrically Conductive Polymer

8.0 g of 3,4-ethylenedioxythiophene was added to 1,000 mL of a 2% by mass aqueous solution of polystyrenesulfonic acid (molecular weight: about 100,000) and mixed at 20° C. To this mixed solution was added 100 mL of an oxidation catalyst solution (containing 15% by mass of ammonium persulfate and 4.0% by mass of ferric sulfate), and the mixture was then allowed to react with stirring at 20° C. for 3 hours.

1,000 mL of ion-exchanged water was added to the obtained reaction solution, and thereafter, about 1,000 mL of the solution was removed by means of ultrafiltration. This operation was repeated three times.

Thereafter, 100 mL of a sulfuric acid aqueous solution (10% by mass) and 1,000 mL of ion-exchanged water were added to the obtained solution, and about 1,000 mL of the solution was removed by means of ultrafiltration. After 1,000 mL of ion-exchanged water was added to the obtained solution, about 1,000 mL of the solution was removed by means of ultrafiltration. This operation was repeated 5 times. There was thus obtained an aqueous solution of about 1.1% by mass of PEDOT.PSS (poly(3,4-ethylenedioxythiophene).polystyrenesulfonic acid) was obtained. A concentration of solids was adjusted with ion-exchanged water to form a 1.0% by mass aqueous solution. In this way, a solution (A) of electrically conductive polymer was prepared. This solution (A) is an aqueous solution, and a dielectric constant of water is 80.

### Preparation Example 1-2

### Preparation of Acetone Solution (B) of Electrically Conductive Polymer

After adding 200 mL of acetone to 200 mL of the aqueous solution (A) of PEDOT.PSS prepared in Preparation Example 1-1, 210 mL of water and acetone were removed by means of ultrafiltration. This operation was performed one time, and a concentration of solids was adjusted with acetone to prepare a 1.0% by mass water/acetone solution. To 200 mL of this solution, 500 mL of acetone having 2.0 g of trioctylamine dissolved therein was added, and the mixture was then stirred with a stirrer for 3 hours. 510 mL of water and acetone were removed by means of ultrafiltration, and a concentration of solids was adjusted with acetone to form a 1.0% by mass acetone solution. In this way, a solution (B) of electrically conductive polymer was prepared. A water content of this solution was 2% by mass, and a dielectric constant of this solvent was 22.7.

### Preparation Example 1-3

### Preparation of Methyl Ethyl Ketone Solution (C) of Electrically Conductive Polymer

300 mL of methyl ethyl ketone was added to 200 mL of the solution (B) of PEDOT.PSS prepared in Preparation Example 1-2 and mixed. The mixed solution was concentrated at room temperature under reduced pressure, and the concentration was continued until a total amount reached 200 mL. The solid content was adjusted with methyl ethyl ketone to form a 1.0% by mass methyl ethyl ketone solution. In this way, a solution (C) of electrically conductive polymer (liquid dispersion (C)) was prepared. A water content of this solution was 0.05% by mass, and an acetone residual ratio was not more than 1% by mass. A dielectric constant of this solvent was 15.5. A content of the electrically conductive polymer in the solids contained in this solution is 50% by mass.

### (Preparation of Coating Solution for Antistatic Layer)

Respective components were mixed as shown in Table 1 below, and the mixture was dissolved in a mixed solvent of methyl ethyl ketone (MEK) and isopropyl alcohol (IPA) to prepare coating solutions HC1 to HC14 for antistatic layer each having a concentration of solids of 30% by mass Since the additives of HC5 to HC14 were sparingly soluble in MEK/IPA, 10% aqueous solutions were prepared and added.

TABLE 1

| | Content (solid content) | | | | | | | | | | | |
|---|---|---|---|---|---|---|---|---|---|---|---|---|
| | Electrically | | | | | | | | | | | |
| | Conductive | | | | | | | | | | | |
| | Polymer Liquid | | | | | | | | | | | |
| | Dispersion | | Polyfunctional Monomer | | | Initiator | | Additive | | | | |
| Coating | | Amount | | Molecu- | Amount | | Amount | | Hydroxyl | Amount | | |
| Solution | | (mass | | lar | (mass | | (mass | | Group | (mass | Diluting | |
| No. | Kind | %) | Kind | Weight | %) | Kind | %) | Kind | Equivalent | %) | Solvent | Remarks |
| HC1 | Liquid | 5 | A-TMMT | 352 | 92 | Irg. 127 | 3 | — | — | — | MEK (30)/ | Comparative |
| | Dispersion | | | | | | | | | | IPA (70) | Example |
| | C | | | | | | | | | | | |
| HC2 | Liquid | 25 | A-TMMT | 352 | 72 | Irg. 127 | 3 | — | — | — | MEK (30)/ | Comparative |
| | Dispersion | | | | | | | | | | IPA (70) | Example |
| | C | | | | | | | | | | | |
| HC3 | Liquid | 5 | A-TMMT | 352 | 91 | Irg. 127 | 3 | diethylene glycol | 53.1 | 1 | MEK (30)/ | Comparative |
| | Dispersion | | | | | | | | | | IPA (70) | Example |
| | C | | | | | | | | | | | |
| HC4 | Liquid | 5 | A-TMMT | 352 | 91 | Irg. 127 | 3 | hydroquinone | 55.1 | 1 | MEK (30)/ | Comparative |
| | Dispersion | | | | | | | | | | IPA (70) | Example |
| | C | | | | | | | | | | | |
| HC5 | Liquid | 5 | A-TMMT | 352 | 91 | Irg. 127 | 3 | tetrahydroxy- | 43.0 | 1 | MEK (30)/ | Comparative |
| | Dispersion | | | | | | | benzoquinone | | | IPA (70) | Example |
| | C | | | | | | | | | | | |
| HC6 | Liquid | 5 | A-TMMT | 352 | 91 | Irg. 127 | 3 | erythritol | 30.5 | 1 | MEK (30)/ | Invention |
| | Dispersion | | | | | | | | | | IPA (70) | |
| | C | | | | | | | | | | | |
| HC7 | Liquid | 5 | A-TMMT | 352 | 91.7 | Irg. 127 | 3 | erythritol | 30.5 | 0.3 | MEK (30)/ | Invention |
| | Dispersion | | | | | | | | | | IPA (70) | |
| | C | | | | | | | | | | | |
| HC8 | Liquid | 5 | A-TMMT | 352 | 89 | Irg. 127 | 3 | erythritol | 30.5 | 3 | MEK (30)/ | Invention |
| | Dispersion | | | | | | | | | | IPA (70) | |
| | C | | | | | | | | | | | |
| HC9 | Liquid | 5 | A-TMMT | 352 | 91 | Irg. 127 | 3 | volemitol | 30.3 | 1 | MEK (30)/ | Invention |
| | Dispersion | | | | | | | | | | IPA (70) | |
| | C | | | | | | | | | | | |
| HC10 | Liquid | 5 | A-TMMT | 352 | 91 | Irg. 127 | 3 | polyvinyl alcohol | 55.7 | 1 | MEK (30)/ | Invention |
| | Dispersion | | | | | | | | | | IPA (70) | |
| | C | | | | | | | | | | | |
| HC11 | Liquid | 5 | A-TMMT | 352 | 91 | Irg. 127 | 3 | pentaerythritol | 34.0 | 1 | MEK (30)/ | Invention |
| | Dispersion | | | | | | | | | | IPA (70) | |
| | C | | | | | | | | | | | |
| HC12 | Liquid | 5 | A-TMMT | 352 | 91 | Irg. 127 | 3 | diglycerol | 41.5 | 1 | MEK (30)/ | Invention |
| | Dispersion | | | | | | | | | | IPA (70) | |
| | C | | | | | | | | | | | |
| HC13 | Liquid | 5 | DPHA | 570 | 91 | Irg. 127 | 3 | erythritol | 30.5 | 1 | MEK (30)/ | Invention |
| | Dispersion | | | | | | | | | | IPA (70) | |
| | C | | | | | | | | | | | |
| HC14 | Liquid | 5 | AD-TMP | 466 | 91 | Irg. 127 | 3 | erythritol | 30.5 | 1 | MEK (30)/ | Invention |
| | Dispersion | | | | | | | | | | IPA (70) | |
| | C | | | | | | | | | | | |

In the Table above, the unit of the numerical value in the parenthesis of the diluting solvent is mass %. The same are also applicable to the following tables.

The compounds used are as follows.

### A-TMMT:

Pentaerythritol tetraacrylate (produced by Shin-Nakamura Chemical Co., Ltd.)

### AD-TMP:

Ditrimethylolpropane tetraacrylate (produced by Shin-Nakamura Chemical Co., Ltd.)

### DPHA:

A mixture of dipentaerythritol pentaacrylate and dipentaerythritol hexaacrylate (produced by Nippon Kayaku Co., Ltd.)

### Irg. 127:

A photopolymerization initiator, Irgacure 127 (produced by Ciba Specialty Chemicals Corp.)

As for the polyvinyl alcohol, PVA 203 (weight average molecular weight (Mw): 10,000 to 20,000, saponification degree: from 87 to 89 mol %) produced by Kuraray Co., Ltd. was used.

### (Preparation of Liquid Dispersion (E) of Hollow Silica Particle)

20 parts of acryloyloxypropyltrimethoxysilane and 1.5 parts of diisopropoxyaluminum ethyl acetate were added to 500 parts of a fine particle sol of hollow silica particle (isopropyl alcohol silica sol, CS60-IPA, manufactured by Catalysts & Chemicals Industries Co., Ltd., average particle diameter: 60 nm, thickness of shell: 10 nm, silica concentration: 20%, refractive index of silica particle: 1.31) and mixed, followed by adding 9 parts of ion-exchanged water. The mixture was allowed to react at 60° C. for 8 hours, and the reaction solution was then cooled to room temperature, followed by adding 1.8 parts of acetyl acetone to obtain a liquid dispersion (D). Thereafter, solvent replacement by means of vacuum distillation was performed under a pressure of 30 Torr while adding cyclohexanone so as to keep the silica content substantially constant, and finally, the concentration was adjusted to obtain a liquid dispersion (E) having a concentration of solids of 18.2%. The amount of IPA remaining in the obtained liquid dispersion was analyzed by means of gas chromatography and found to be not more than 0.5%.

### (Preparation of Coating Solution for Low Refractive Index Layer)

Respective components were mixed as shown in Table 2, and the mixture was dissolved in MEK to fabricate a coating solution for low refractive index layer having a solid content of 5%.

TABLE 2

| | Content (solids) | | | | | | | |
|---|---|---|---|---|---|---|---|---|
| | | | | | | | | Liquid |
| | | | | | | | | dispersion |
| | | | | | Polymerization | | | (E) of |
| | Binder | | | | initiator | | RMS-033 | hollow silica |
| Coating | | Amount | | Amount | | Amount | (amount: % | (amount: % |
| solution No. | Kind | (% by mass) | Kind | (% by mass) | Kind | (% by mass) | by mass) | by mass) |
| Ln 1 | P-1 | 28 | DPHA | 10 | Irg. 127 | 3 | 4 | 55 |
| Ln 2 | DPHA | 38 | — | — | Irg. 127 | 3 | 4 | 55 |

Incidentally, the abbreviations in the foregoing Table 2 are as follows.

P-1: Fluorine-containing copolymer P-3 (weight average molecular weight: about 50,000) described in JP-A-2004-45462

DPHA: A mixture of dipentaerythritol pentaacrylate and dipentaerythritol hexaacrylate, manufactured by Nippon Kayaku Co., Ltd.

Irg. 127: Irgacure 127, a polymerization initiator (manufactured by Ciba Japan K.K.)

RMS-033: Methacryloxy-modified silicone (manufactured by Gelest)

### (Fabrication of Antistatic Layer)

On a triacetyl cellulose film (TD80UF, manufactured by Fujifilm Corporation, refractive index: 1.48) having a thickness of 80 μm as a transparent support, the above-prepared coating solution for antistatic layer was coated using a gravure coater. After drying at 60° C. for about one minute, the coated layer was cured by irradiating ultraviolet rays at an illuminance of 400 mW/cm² and an irradiation dose of 120 mJ/cm² with use of an air-cooled metal halide lamp (manufactured by Eye Graphics Co., Ltd.) of 160 W/cm while purging the system with nitrogen to give an atmosphere having an oxygen concentration of not more than 1.0% by volume, thereby forming an antistatic layer having a thickness of 5 μm. In this way, optical films (Samples Nos. 1 to 16) were fabricated.

### (Fabrication of Low Refractive Index Layer)

The coating solution for low refractive index layer was coated using a gravure coater on the above-fabricated antistatic layer Sample No. 6. A drying condition of the low refractive index layer was 60° C. and 60 seconds, and an ultraviolet curing condition was such that an air-cooled metal halide lamp (manufactured by Eye Graphics Co., Ltd.) of 240 W/cm was used at an illuminance of 600 mW/cm² and an irradiation dose of 600 mJ/cm² while purging the system with nitrogen to give an atmosphere having an oxygen concentration of not more than 0.01% by volume. In this way, optical films (antireflection films) in which a low refractive index layer was formed on the antistatic layer were fabricated (Samples Nos. 15 and 16).

### (Evaluation of Optical Film)

Various characteristics of the optical film were evaluated by the following methods. The results are shown in Table 3.

### (1) Measurement of Surface Resistivity (Ω/□) (Also Referred to as Ω/sq.)

A value measured using a super-insulation resistance/microammeter TR8601 (manufactured by Advantest Corp.) after leaving the sample to stand under the conditions of 25° C. and 60% RH for 2 hours is shown by the common logarithm (log SR).

### (2) Evaluation of Pencil Hardness:

As an index of scratch resistance, a pencil hardness evaluation described in JIS K5400 was performed. The antireflection film was subjected to humidity conditioning at a temperature of 25° C. and a humidity of 60% RH for 2 hours and then evaluated using a pencil for test prescribed in JIS 56006.

### (3) Transmittance:

A transmittance of light at 550 nm was measured using an UV/vis spectrometer (Shimadzu U2400). The transmittance is preferably 90% or more, and more preferably 92% or more.

### (4) Light Resistance Test:

Light was irradiated at an output of 180 W/m² for 50 hours by using a super xenon weather meter, SX-75 (manufactured by Suga Test Instruments Co., Ltd.), and a surface resistivity was then measured by the foregoing method.

### (6) Integrated Reflectance:

After roughening a back surface (surface not having an optical functional layer) of the optical film with sand paper to eliminate the reflection on the back surface and then treating the back surface with a black ink, an integrated reflectance was measured with a spectral photometer, V-550 (manufactured by JASCO Corporation), and an average reflectance of from 450 to 650 nm was calculated, thereby evaluating antireflection properties.

TABLE 3

| | Antistatic | | Low Refractive | | | | | | | | |
|---|---|---|---|---|---|---|---|---|---|---|---|
| | Layer | | Index | | | | | | | | |
| | | Film | Layer | | | | Integrated | Surface Resistivity (Ω/sq.) | | | |
| Sample | Coating | Thick- | Coating | Film | Transmittance | Pencil | Reflectance | Before Light | After Light | Range of | |
| No. | Solution | ness | Solution | Thickness | (%) | Hardness | (%) | Irradiation | Irradiation | Change | Remarks |
| 1 | HC1 | 5 μm | — | — | 92.1 | 3H | 4.7 | 9.3 | 13.3 | 4.0 | Comparative |
| | | | | | | | | | | | Example |
| 2 | HC2 | 5 μm | — | — | 87.2 | B | 4.7 | 5.0 | 11.1 | 6.1 | Comparative |
| | | | | | | | | | | | Example |
| 3 | HC3 | 5 μm | — | — | 92.1 | 3H | 4.7 | 8.5 | 12.0 | 3.5 | Comparative |
| | | | | | | | | | | | Example |
| 4 | HC4 | 5 μm | — | — | not cured | — | — | — | — | — | Comparative |
| | | | | | | | | | | | Example |
| 5 | HC5 | 5 μm | — | — | 92.1 | H | 4.7 | 8.5 | 10.1 | 1.6 | Comparative |
| | | | | | | | | | | | Example |
| 6 | HC6 | 5 μm | — | — | 92.1 | 3H | 4.7 | 7.6 | 9.3 | 1.7 | Invention |
| 7 | HC7 | 5 μm | — | — | 92.1 | 3H | 4.7 | 8.4 | 10.7 | 2.3 | Invention |
| 8 | HC8 | 5 μm | — | — | 92.1 | 3H | 4.7 | 7.6 | 9.2 | 1.6 | Invention |
| 9 | HC9 | 5 μm | — | — | 92.1 | 3H | 4.7 | 8.1 | 10.0 | 1.9 | Invention |
| 10 | HC10 | 5 μm | — | — | 92.1 | 3H | 4.7 | 8.7 | 11.0 | 2.3 | Invention |
| 11 | HC11 | 5 μm | — | — | 92.1 | 3H | 4.7 | 8.0 | 9.6 | 1.6 | Invention |
| 12 | HC12 | 5 μm | — | — | 92.1 | 3H | 4.7 | 8.4 | 10.4 | 2.0 | Invention |
| 13 | HC13 | 5 μm | — | — | 92.1 | 3H | 4.7 | 8.7 | 10.9 | 2.2 | Invention |
| 14 | HC14 | 5 μm | — | — | 92.1 | 3H | 4.7 | 8.1 | 10.0 | 1.9 | Invention |
| 15 | HC6 | 5 μm | Ln 1 | 90 nm | 94.5 | 3H | 1.5 | 7.6 | 8.8 | 1.2 | Invention |
| 16 | HC6 | 5 μm | Ln 2 | 90 nm | 93.7 | 3H | 1.9 | 7.6 | 8.8 | 1.2 | Invention |

As is clear from the results shown in the foregoing Table 3, it is noted that the optical film of Sample No. 1 composed of only the electrically conductive polymer (A) and the polyfunctional monomer (B) having two or more polymerizable groups is inferior in the light resistance. Also, it is noted that the optical film of Sample No. 2 in which the content of the electrically conductive polymer (A) was increased relative to the optical film of Sample No. 1 from the viewpoint of maintaining the light resistance, a lowering of the hardness of the coating film and a lowering of the transmittance to be caused due to coloration occurred.

Also, it is noted that the optical film of Sample No. 3 using a non-aromatic alcohol compound having two hydroxyl groups is inferior in the light resistance.

Furthermore, it is noted that the optical film of Sample No. 4 using a compound having an aromatic hydroxyl group was not cured, so that a film could not be formed. It is noted that the optical film of Sample No. 5 using a compound having four aromatic hydroxyl groups was insufficient in the film strength and inferior in the light resistance.

On the other hand, it is noted that the optical films having an antistatic layer formed of a composition containing the electrically conductive polymer (A), the polyfunctional monomer (B) having two or more polymerizable groups, the non-aromatic alcohol compound (C) having four or more hydroxyl groups, and the polymerization initiator (D) (Samples Nos. 6 to 14) had a pencil hardness of 3H or more and high film strength, had excellent antistatic properties because of high transparency and high electrical conductivity, and had excellent light resistance because of a variation width of the surface resistivity value before and after the irradiation with light of not more than 2.5. Also, in the optical films of Samples Nos. 15 and 16 in which the low refractive index layer was further stacked on the antistatic layer, the films having a low reflectance and less glare were obtained.

Also, in the optical films of Samples Nos. 15 and 16 in which the low refractive index layer was stacked, the light resistance was enhanced. It may be considered that this was caused due to a reduction of the exposure amount to oxygen/light by stacking.

### Example 2

### Preparation of Coating Solution for Antistatic Layer

Respective components were mixed as shown in Table 4 below, and the mixture was dissolved in a mixed solvent of methyl ethyl ketone and IPA to prepare coating solutions HC6 and HC15 for antistatic layer each having a concentration of solids of 30% by mass.

TABLE 4

| | Content (solid content) | | | | | | | | | | | |
|---|---|---|---|---|---|---|---|---|---|---|---|---|
| | Electrically | | | | | | | | | | | |
| | Conductive | | | | | | | | | | | |
| | Polymer Liquid | | Polyfunctional | | | | | | | | | |
| Coating | Dispersion | | Monomer | | Initiator | | Additive | | Surfactant | | | |
| Solution | | Amount | | Amount | | Amount | | Amount | | Amount | Diluting | |
| No | Kind | (mass %) | Kind | (mass %) | Kind | (mass %) | Kind | (mass %) | Kind | (mass %) | Solvent | Remarks |
| HC6 | Liquid | 5 | A-TMMT | 91 | Irg. 127 | 3 | erythritol | 1 | — | — | MEK (30)/ | Invention |
| | Dispersion C | | | | | | | | | | IPA (70) | |
| HC15 | Liquid | 5 | A-TMMT | 91 | Irg. 127 | 3 | erythritol | 1 | FP1 | 0.1 | MEK (30)/ | Invention |
| | Dispersion C | | | | | | | | | | IPA (70) | |

In the foregoing Table 4, the abbreviation is as follows.

FP-1: A fluorine based surfactant represented by the following structural formula.

The numerical value attached to each structural unit (the numerical value attached to the repeating unit of the main chain) indicates the content (mol %) of the structural unit.

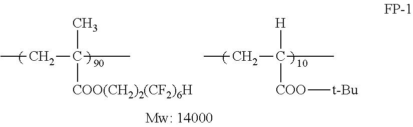

### (Fabrication of Optical Film)

Sample No. 17 was fabricated in the same manner as that in Example 1, except that in Sample No. 1, the coating solution for antistatic layer was changed to HC15.

### (Evaluation of Optical Film)

Various characteristics of the optical film were evaluated by the same methods as those described above. Also, the following evaluation of surface roughness (5) was performed.

### (5) Evaluation of Surface Roughness:

An oil based black ink was applied to the back side of the sample, and the surface roughness was evaluated by visually observing the sample under sunlight source according to the following criteria.

1: Roughness of the film surface is recognized at a glance and is very annoying.

2: The film surface is slightly roughened, and the roughness is annoying.

3: Roughness of the film surface is recognized when carefully checked but is not annoying.

4: Roughness of the film surface cannot be recognized even when carefully checked.

Incidentally, so far as the evaluation result indicates 3 or 4, there is no problem from the practical use.

The results are shown in Table 5.

TABLE 5

| | | | | | | | Surface | | |
|---|---|---|---|---|---|---|---|---|---|
| | | | | | | | resistance value | | |
| | | | | | | | (Ω/□) | | |
| | Antistatic layer | | | | Integrated | | Before | After | |
| Sample | Coating | Film | Transmittance | Pencil | reflectance | Surface | irradiation | irradiation | |
| No. | solution | thickness | (%) | hardness | (%) | roughness | with light | with light | Remark |
| 6 | HC6 | 5 μm | 92.1 | 3H | 4.7 | 3 | 7.6 | 9.3 | Invention |
| 17 | HC15 | 5 μm | 92.1 | 3H | 4.7 | 4 | 7.6 | 8.8 | Invention |

As is clear from the results shown in the foregoing Table 5, it is noted that by further adding a surfactant to the antistatic layer containing the electrically conductive polymer (A), the polyfunctional monomer (B) having two or more polymerizable groups, the non-aromatic alcohol compound (C) having four or more hydroxyl groups, and the photopolymerization initiator (D), high antistatic properties can be realized while keeping a very favorable surface profile. Also, though there may be a possibility that the use of a surfactant adversely affects the surface resistivity, in the invention, even when the surfactant was used, the electrical conductivity was not deteriorated.

### Example 3

Sample Nos. 18 and 19 were produced in the same manner as Sample No. 1 of Example 1 except that the coating solution for antistatic layer was changed to HC16 or HC17 shown in the Table below and the film thickness after curing was also changed to 12 μm. These samples were evaluated in the same manners as those in Example 1.

TABLE 6

| | Content (solids) | | | | | | | | | | | | | |
|---|---|---|---|---|---|---|---|---|---|---|---|---|---|---|
| | Liquid dispersion of | | | | | | | | | | | | | |
| | electrically | | | | | | | | | | | | | |
| | conductive polymer | | Polyfunctional monomer | | | | Initiator | | Additive | | Translucent particle | | | |
| Coating | | Amount | | Amount | | Amount | | Amount | | Amount | | Amount | | |
| solution | | (% by | | (% by | | (% by | | (% by | | (% by | | (% by | Diluent | |
| No. | Kind | mass) | Kind | mass) | Kind | mass) | Kind | mass) | Kind | mass) | Kind | mass) | solvent | Remark |
| HC16 | Liquid | 5 | PET- | 42.5 | Viscoat | 42.5 | Irg. | 3 | — | — | 8-μm | 7 | MEK(30)/ | Com- |
| | dispersion | | 30 | | 360 | | 127 | | | | crosslinked | | IPA(70) | parison |
| | C | | | | | | | | | | acryl-styrene | | | |
| | | | | | | | | | | | particle | | | |
| HC17 | Liquid | 5 | PET- | 42 | Viscoat | 42 | Irg. | 3 | Erythritol | 1 | 8-μm | 7 | MEK(30)/ | Inven- |
| | dispersion | | 30 | | 360 | | 127 | | | | crosslinked | | IPA(70) | tion |
| | C | | | | | | | | | | acryl-styrene | | | |
| | | | | | | | | | | | particle | | | |

TABLE 7

| | | | | | | Surface | | |
|---|---|---|---|---|---|---|---|---|
| | | | | | | resistance value | | |
| | | | | | | (Ω/□) | | |
| | Antistatic layer | | | | Integrated | Before | After | |
| | Coating | Film | Transmittance | Pencil | reflectance | irradiation | irradiation | |
| Sample No. | solution | thickness | (%) | hardness | (%) | with light | with light | Remark |
| 18 | HC16 | 12 μm | 91.5 | 3H | 4.6 | 8.6 | 13.3 | Comparison |
| 19 | HC17 | 12 μm | 91.5 | 3H | 4.6 | 7.6 | 8.8 | Invention |

As described above, Sample No. 19 containing a translucent particle in the antistatic layer was a film having less glare because it had high film strength, excellent transparency and antistatic properties, and excellent light resistance and had antiglare properties.

The compounds used in the foregoing Table 6 are as follows.

PET-30: A mixture of pentaerythritol triacrylate and pentaerythritol tetraacrylate [manufactured by Nippon Kayaku Co., Ltd.]

Viscoat 360: Trimethylolpropane PO-modified triacrylate [manufactured by Osaka Organic Chemical Industry Ltd.]

8-μm crosslinked acryl-styrene particle (30%): An MIBK (methyl isobutyl ketone) liquid dispersion obtained by dispersing a crosslinked acryl-styrene particle having an average particle diameter of 8.0 μm (manufactured by Sekisui Chemical Co., Ltd.) in a polytron dispersing machine at 10,000 rpm for 20 minutes; refractive index: 1.55

### Example 4

### Evaluation on Liquid Crystal Display Device

### (Fabrication of Polarizing Plate)

A triacetyl cellulose film having a thickness of 80 μm (TAC-TD80U, manufactured by Fujifilm Corporation) which had been dipped in a 1.5 moles/L NaOH aqueous solution at 55° C. for 2 minutes, then neutralized and washed, and the optical film (saponified) of each of the Examples and Comparative Examples were allowed to adhere to each other and caused to protect both surfaces of a polarizer fabricated by adsorbing iodine to a polyvinyl alcohol and stretching it. There was thus fabricated a polarizing plate.

### (Fabrication of Liquid Crystal Display Device)

The polarizing plate and the retardation film provided in a VA type liquid crystal display device (LC-37GS10, manufactured by Sharp Corporation) were removed, and the above-fabricated polarizing plate was instead stacked by arranging its transmission axis to agree with that of the polarizing plate originally stacked to the commercial product. There were thus fabricated liquid crystal display devices having the optical film of each of the Examples and Comparative Example. Incidentally, the optical film was stacked such that it was located on the viewing side.

In the thus-fabricated polarizing plate and image display device each with the optical film of each of the Examples, similarly to respective optical films stacked, a good surface profile free of streak or unevenness, excellent scratch resistance due to high film strength, and antifouling properties and dustproof properties due to excellent antistatic properties were exhibited as compared with the Comparative Examples. Also, in the polarizing plate and image display device each with an optical film where a low refractive index is stacked or with an optical film where antiglare properties are imparted, significantly reduced disturbing reflection of the background and very high display quality were achieved.

This application is based on a Japanese patent application filed on Mar. 1, 2011 (Japanese Patent Application No. 2011-44548), and a Japanese patent application filed on Feb. 28, 2012 (Japanese Patent Application No. 2012-41923) and the contents thereof are incorporated herein by reference.

What is claimed is:

1. An optical film comprising a transparent support having thereon at least one layer of an antistatic layer formed of a composition containing at least the following (A) to (D):
(A) an electrically conductive polymer,
(B) a polyfunctional monomer having two or more polymerizable group,
(C) a non-aromatic alcohol compound having four or more hydroxyl groups, and
(D) a photopolymerization initiator.

2. The optical film according to claim 1, wherein the non-aromatic alcohol compound (C) is an aliphatic hydrocarbon compound having a main chain structure with a carbon number of 4 or more.

3. The optical film according to claim 1, wherein the non-aromatic alcohol compound (C) has from four to six hydroxyl groups.

4. The optical film according to claim 1, wherein the main chain structure of the non-aromatic alcohol compound (C) is linear.

5. The optical film according to claim 1, wherein the hydroxyl group equivalent (molecular weight/number of hydroxyl groups) of the non-aromatic alcohol compound (C) is 40 or less.

6. The optical film according to claim 1, wherein the molecular weight of the polyfunctional monomer (B) is 400 or less.

7. The optical film according to claim 1, wherein a common logarithmic value (log SR) of a surface resistivity SR (Ω/sq) of the optical film is in the range of from 6 to 12.

8. The optical film according to claim 1, wherein the electrically conductive polymer (A) contains at least any one of polythiophene, polyaniline, polypyrrole, and derivatives thereof.

9. The optical film according to claim 1, wherein the electrically conductive polymer (A) contains at least any one of polythiophene and derivatives thereof.

10. The optical film according to claim 1, wherein the electrically conductive polymer (A) contains poly(3,4-ethylenedioxy)thiophene.

11. The optical film according to claim 1, further comprising polystyrenesulfonic acid as a dopant of the electrically conductive polymer (A).

12. The optical film according to claim 1, wherein the composition further contains (E) a fluorine based or silicone based surfactant.

13. The optical film according to claim 1, wherein the antistatic layer contains a translucent particle having an average particle diameter of from 0.5 to 20 μm.

14. An antireflection film comprising the antistatic layer of the optical film according to claim 1 having thereon a low refractive index layer directly or via other layer.

15. A polarizing plate utilizing, as a protective film for polarizing plate, the optical film according to claim 1.

16. An image display device comprising the optical film according to claim 1 on an outermost surface of a display.
